(19) United States
(12) Patent Application Publication
(10) Pub. No.: US 2010/0005166 A1
(43) Pub. Date: Jan. 7, 2010

(54) NETWORK DEVICE

(76) Inventor: Jong-Hoon Chung, Gunpo-si (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/162,201

(22) PCT Filed: Jan. 26, 2007
(86) PCT No.: PCT/KR07/00483

§ 371 Date: Dec. 30, 2008

Related U.S. Application Data
(60) Provisional application No. 60/762,784, filed on Jan. 27, 2006.

(51) Int. Cl. G06F 15/173; G06F 21/00

(52) U.S. Cl. 709/224; 726/26; 709/223

(57) ABSTRACT

The present invention discloses a network device which can access a home network system and perform network communication based on a predetermined protocol, by using a minimum number of resources of an embedded microcontroller The network device communicates with at least one electric device through a network. The network device adopts a protocol consisting of an application layer for processing a message for controlling or monitoring the electric device, a network layer for performing network connection to the electric device, a data link layer for accessing a shared transmission medium, and a physical layer for providing a physical interface with the electric device. The application layer further includes an application sublayer for performing a network management function or managing device information.

### TECHNICAL FIELD

The present invention relates to a network device, and more particularly to, a network device which can access a home network system and perform network communication based on a predetermined protocol, by using a minimum number of resources of an embedded microcontroller.

### BACKGROUND ART

A home network connects various digital home appliances so that the user can always enjoy convenient, safe and economic life services inside or outside the house. Refrigerators or washing machines called white home appliances have been gradually digitalized with the development of the digital signal processing technology, the home appliance operating system technology and the high speed multimedia communication technology have been intensively applied to the digital home appliances, and new information home appliances have been developed, to improve the home network.

As shown in Table 1, the home network is classified into a data network, an entertainment network and a living network according to types of services.

TABLE 1

| Classification | Function | Service type |
|---|---|---|
| Data network | Network between PC and | Data exchange, internet |
| | peripheral devices | service, etc. |
| Entertainment | Network between A/V | Music, animation service, etc. |
| network | devices | |
| Living | Network for controlling | Home appliances control, |
| network | home appliances | home automation, remote |
| | | meter reading, message |
| | | service, etc. |

Here, the data network is built to exchange data between a PC and peripheral devices or provide an internet service, and the entertainment network is built between home appliances using audio or video information. The living network is built to control home appliances, such as home automation or remote meter reading.

A home network system installed in a household includes a master device which is a network device for controlling operations of the other network devices, namely, the other home appliances, or monitoring a status thereof, and a slave device which is a network device responding to a request of the master device and notifying the status change according to the network device characteristic or other factors. Exemplary network devices include home appliances for the living network service such as a washing machine and a refrigerator, home appliances for the data network service and the entertainment network service, and products such as a gas valve control apparatus, an automatic door apparatus and an electric lamp.

In the conventional art, the network device for the home network system is a high performance device, or configures a network by using a large portion of resources of an embedded microcontroller. As a result, the production cost of the network device increases. Furthermore, when the network device performs an individual function (for example, washing, drying, etc.), the resources of the microcontroller are deficient.

### DISCLOSURE OF THE INVENTION

The present invention is achieved to solve the above problems. An object of the present invention is to provide a network device which can use a control protocol which is a generalized communication standard for supplying functions for controlling and monitoring the other network devices in a home network system.

Another object of the present invention is to provide a network device which can perform network communication and a self function in spite of low performance, by supplying a plurality of unified primitives for transmitting data.

Yet another object of the present invention is to provide a network device which can perform network security and information processing according to network media.

Yet another object of the present invention is to provide a network device which can allow an electric device to perform network communication through an adapter by communication with the adapter, even if the electric device does not have a high performance communication module.

Yet another object of the present invention is to provide a network device which can perform communication security according to transmission media through a home code sublayer of a data link layer.

Yet another object of the present invention is to provide a method for setting an address of a network device which can set a unique logical address of a network manager, when the network manager is newly connected to a network.

Yet another object of the present invention is to provide a method for setting a function of a network manager which can set a primary network manager and a secondary network manager according to versions of the network managers or selection of the user.

Yet another object of the present invention is to provide a method for setting a function of a network manager which can maintain a network management function, by transferring a network management function of a primary network manager plugged out of a network to another network manager.

In order to achieve the above-described objects of the invention, there is provided a network device communicating with at least one electric device through a network, the network device adopting a protocol including: an application layer for processing a message for controlling or monitoring the electric device; a network layer for performing network connection to the electric device; a data link layer for accessing a shared transmission medium; and a physical layer for providing a physical interface with the electric device, wherein the application layer further includes an application sublayer for performing a network management function or managing device information.

In another aspect of the present invention, there is provided a network adapter for performing data transmission between a first network and a second network, the network adapter adopting a protocol including: a first layer unit for performing communication through the first network; a second layer unit for performing communication through the second network; and an upper layer for performing communication between the first layer unit and the second layer unit, wherein, when the first network or the second network is a non-independent transmission medium, the first layer unit or the second layer unit includes a home code control sublayer for managing a home code for network security.

In yet another aspect of the present invention, there is provided a network device, including: an electric device performing an intrinsic function, and including an upper layer for processing a message for controlling or monitoring; and an adapter including a lower layer for performing communication through a network, an interface layer between the upper layer and the lower layer being formed in the electric device and the adapter, respectively.

In yet another aspect of the present invention, there is provided a network device, including: an electric device performing an intrinsic function, and including an upper layer for processing a message for controlling or monitoring and performing network communication with another electric device; and an adapter including a lower layer for accessing a network which is a transmission medium, an interface layer between the upper layer and the lower layer being formed in the electric device and the adapter, respectively.

In yet another aspect of the present invention, there is provided a method for setting an address of a network device communicating with another network device through a network, the method including the steps of: sending, at one network device, a configuration request message to another network device; when one network device receives a response message to the configuration request message, setting a logical address contained in the response message as a logical address of one network device; and when one network device does not receive the response message to the configuration request message, setting a temporary logical address.

In yet another aspect of the present invention, there is provided a method for setting a function of a network manager communicating with a network device through a network, the method including the steps of: searching, at one network manager, for another network manager; and when another network manager is searched for in the search step, setting one network manager as a primary network manager or a secondary network manager according to a network management function version of the searched network manager.

In yet another aspect of the present invention, there is provided a method for setting a function of a network manager communicating with a network device through a network, the method including the steps of: searching for a network manager; displaying the network manager connected to the network according to the search result; acquiring selection of the user for a primary network manager or a secondary network manager with regard to the displayed network manager; and setting the network manager as the primary network manager or the secondary network manager according to the acquired selection of the user.

In yet another aspect of the present invention, there is provided a method for setting a function of a network manager communicating with a network device through a network, the method including the steps of: checking a plug-out state of a primary network manager; when the primary network manager has the plug-out state according to the checking result, searching, at one network manager, for a secondary network manager; and when the secondary network manager is searched for in the search step, setting one network manager as a primary network manager or a secondary network manager according to a network management function version of the searched secondary network manager.

### BRIEF DESCRIPTION OF THE DRAWINGS

FIG. 1 is a configuration view illustrating a home network system to which a network device is applied in accordance with the present invention;

FIG. 2 is a configuration view illustrating a control protocol stack applied to the network device in accordance with the present invention;

FIGS. 3 and 4 are configuration views illustrating interfaces between layers of FIG. 2, respectively;

FIGS. 5 to 10 are detailed configuration views illustrating the interfaces of FIGS. 3 and 4, respectively;

FIGS. 11 and 12 are configuration views illustrating primitives for transmitting data exchanged between the layers, respectively;

FIG. 13 is a configuration view illustrating the network device to which the control protocol is applied in accordance with the present invention;

FIGS. 14 and 15 are configuration views illustrating examples of routers of FIG. 1;

FIGS. 16 and 17 are configuration views illustrating examples of adapters of FIG. 1;

FIG. 18 is a basic structure view illustrating a transmission/reception data used in the interface;

FIG. 19 is a configuration view illustrating a network manager which is the network device in accordance with the present invention;

FIG. 20 is a flowchart showing sequential steps of a method for setting a logical address of a network manager in accordance with the present invention;

FIG. 21 is a flowchart showing sequential steps of a method for setting a function of a network manager in accordance with a first embodiment of the present invention;

FIG. 22 is a flowchart showing sequential steps of a method for setting a function of a network manager in accordance with a second embodiment of the present invention; and

FIG. 23 is a flowchart showing sequential steps of a method for setting a function of a network manager in accordance with a third embodiment of the present invention.

### BEST MODE FOR CARRYING OUT THE INVENTION

A network device in accordance with the preferred embodiments of the present invention will now be described in detail with reference to the accompanying drawings.

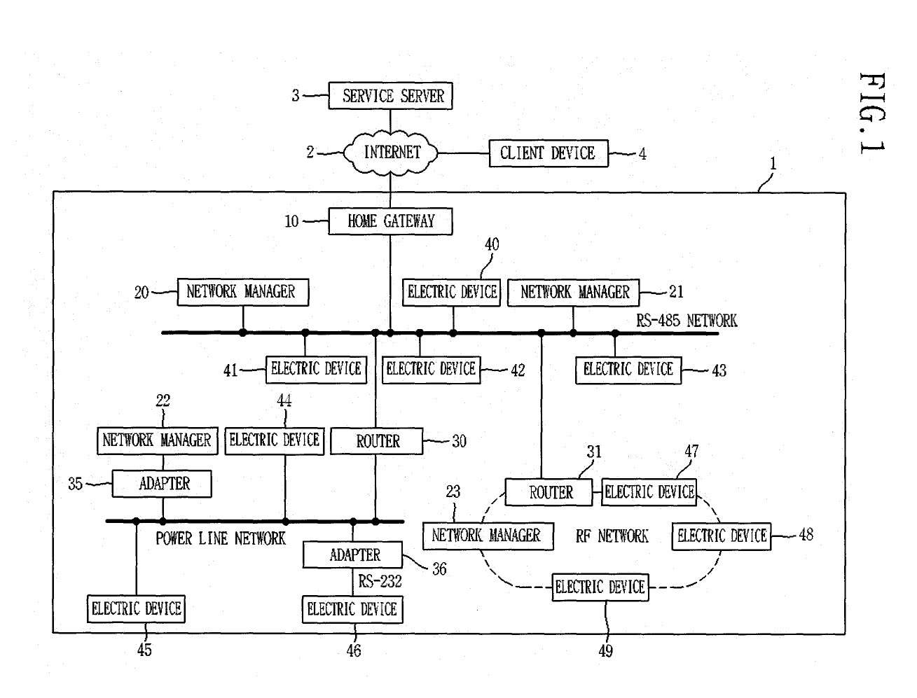

FIG. 1 is a configuration view illustrating a home network system to which the network device is applied in accordance with the present invention.

Referring to FIG. 1, the home network system 1 accesses a service server 3 through an internet 2, and a client device 4 accesses the service server 3 through the internet 2. That is, the home network system 1 is connected to the service server 3 and/or the client device 4 to perform communication.

A network outside the home network system 1 such as the internet 2 includes additional constitutional elements according to a kind of the client device 4. For example, when the client device 4 is a computer, the internet 2 includes a Web server (not shown), and when the client device 4 is a portable terminal or a mobile communication terminal, the internet 2 includes a Wap server (not shown).

The service server 3 is connected respectively to the home network system 1 and the client device 4 according to predetermined login and logout procedures, for receiving monitoring and control commands from the client device 4, and transmitting the commands to the network system 1 through the internet 2 as predetermined types of messages. In addition, the service server 3 receives a predetermined type of message from the home network system 1, and stores the message and/or transmits the message to the client device 4. The service server 3 transmits and receives a stored or generated message to/from the home network system 1. That is, the home network system 1 can access the service server 3 and download the provided contents.

The home network system 1 includes a home gateway 10 for performing connection to the internet 2, network managers 20 to 23 for performing environment setting and management of electric devices 40 to 49, routers 30 and 31 for access between transmission media, adapters 35 and 36 for connecting the network manager 22 and the electric device 46 to the transmission medium, and the plurality of electric devices 40 to 49. Here, the home gateway 10, the electric devices 40 to 49, the network managers 20 to 23, the routers 30 and 31 and the adapters 35 and 36 are examples of the network device.

The network of the home network system 1 can be built by connecting the electric devices 40 to 49 through a shared transmission medium. A data link layer non-standardized transmission medium such as RS-485 and small output RF, a power line, or a standardized transmission medium such as IEEE 802.11 and IEEE 802.15.4 can be used as the transmission medium.

The network in the home network system 1 is formed as an individual network from the internet 2, namely, an independent network using a wire or wireless transmission medium. The independent network means a physically connected but logically divided network.

The home network system 1 includes master devices for controlling the operations of the other electric devices 40 to 49 or monitoring the status thereof, and slave devices for responding to the requests of the master devices and supplying the status change information. The master devices include the network managers 20 to 23, and the slave devices include the electric devices 40 to 49. The network managers 20 to 23 contain information on the corresponding electric devices 40 to 49 and control codes, and control the electric devices 40 to 49 according to a programmed method or an input from the service server 3 and/or the client device 4. Still referring to FIG. 1, in the case that the plurality of network managers 20 to 23 are connected, each of the network managers 20 to 23 must be both the master device and the slave device, namely physically one device but logically the hybrid device serving as a master and a slave in order to perform information exchange, data synchronization and control with the other network managers 20 to 23.

The network managers 20 to 23 and the electric devices 40 to 49 can be connected to the network (power line network, RS-485 network and RF network) directly, or indirectly through the routers 30 and 31 and/or the adapters 35 and 36.

The electric devices 40 to 49 and/or the routers 30 and 31 and/or the adapters 35 and 36 are registered in the network managers 20 to 23, and provided with unique logical addresses (for example, 0x00, 0x01, etc.) according to kinds of products. The logical addresses are combined with product codes (for example, 0x02 of air conditioner, 0x01 of washing machine, etc.), and used as node addresses. The electric devices 40 to 49 and/or the routers 30 and 31 and/or the adapters 35 and 36 can be identified by the node addresses such as 0x0201 (air conditioner 1) and 0x0202 (air conditioner 2). In addition, a group address for identifying at least one electric device 40 to 49 and/or at least one router 30 and 31 and/or at least one adapter 35 and 36 at a time can be used under a predetermined standard (for example, all identical products, installation space of products, user, etc.). In the group address, an explicit group address designates a plurality of devices by setting an address option value (flag mentioned below) as ‘1’, and an implicit group address designates a plurality of devices by filling the whole bit values of the logical address and/or the product code with ‘1’. Especially, the explicit group address is called a cluster code.

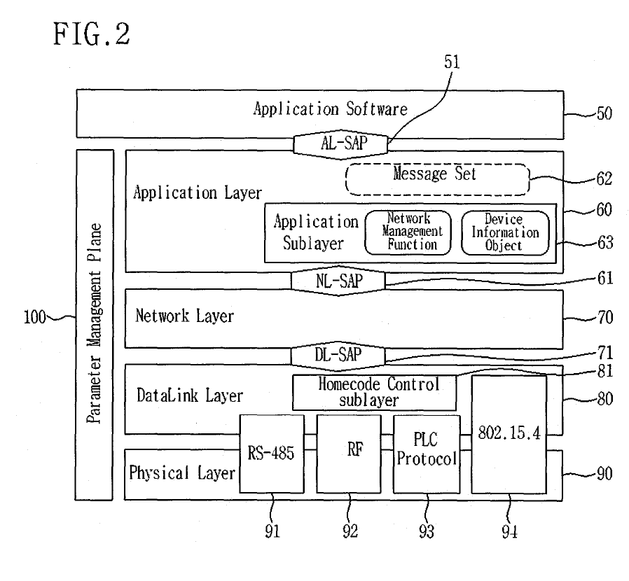

FIG. 2 is a configuration view illustrating a control protocol stack applied to the network device in accordance with the present invention. In the home network system 1, the network managers 20 to 23, the routers 30 and 31, the adapters 35 and 36 and the electric devices 40 to 49 can communicate with each other according to the control protocol of FIG. 2. Therefore, the network managers 20 to 23, the routers 30 and 31, the adapters 35 and 36 and the electric devices 40 to 49 perform network communication according to the control protocol.

As illustrated in FIG. 2, the control protocol applied to the network device of the present invention includes an application software 50 for performing intrinsic functions of the network devices such as the network managers 20 to 23, the routers 30 and 31, the adapters 35 and 36 and the electric devices 40 to 49, and performing data exchange with an application layer 60 through an interface defined in the application layer 60, namely, providing the interface function with the application layer 60 for remote controlling and monitoring on the network, the application layer 60 for defining a transmission/reception control function to execute a service request from the application software 50, providing the service to the user, generating information or a command from the user as a message, and transferring the message to a lower layer, a network layer 70 for performing address management and transmission/reception control of the network devices for reliable network connection of the network managers 20 to 23, the routers 30 and 31, the adapters 35 and 36 and the electric devices 40 to 49, a data link layer 80 for providing a medium access control (MAC) function for accessing the shared transmission medium, a physical layer 90 for transmitting and receiving physical signals such as transmission bits to/from physical interfaces of the network managers 20 to 23, the routers 30 and 31, the adapters 35 and 36 and the electric devices 40 to 49, and a parameter management plane 100 for setting or reading parameters or node parameters used in each layer by the request of the network management function in the application layer 60.

In this description, the embodiment of the application software 50 will not be prescribed.

The application layer 60 defines the transmission/reception control function to execute the service request from the application software 50, and also defines the flow control function for download and upload services. In addition, the application layer 60 defines a message set 62 to manage the network or control and monitor the network devices. The message set 62 contains messages exchanged to perform the services in the application layer 60. Such messages will be explained later in detail.

The application layer 60 transmits and receives services (primitives described below, etc.) to/from the application software 50 through an application layer-service access point (AL-SAP) 51.

The application layer 60 includes an application sublayer 63, and defines a network management function and a device information object.

The network management function defines a parameter management function for setting a parameter, and a function for configuring and managing a network. That is, the network management function defines the parameter management function for setting the parameter in each network device, and the function for configuring the network, setting the environment and managing the network operation. The network management function will be explained later in more detail.

The device information object receives device information from the network device (precisely, the application software 50), manages the device information, and defines a response function to the related request. That is, the device information object acquires the product information on the network device using the control protocol from the application software 50, and stores the product information. If another network device (for example, the master device) requests the device information, the application layer 60 can directly respond to the request, instead of making a request to a microcomputer of the network device through the application software 50.

The network layer 70 transmits and receives services (primitives described below, etc.) to/from the application layer 60 through a network layer-service access point (NL-SAP) 61.

In the case that the data link layer standardized transmission medium is used, the MAC function prescribed in the corresponding protocol and the protocol of the corresponding physical layer 90 can be employed. When the data link layer non-standardized transmission medium is used, probabilistic delayed carrier sense multiple access (p-DCSMA) can be used as a MAC protocol.

The data link layer 80 transmits and receives services (primitives described below, etc.) to/from the network layer 70 through a data link layer-service access point (DL-SAP) 71.

When the network which the network managers 20 to 23, the routers 30 and 31, the adapters 35 and 36 and the electric devices 40 to 49 access is configured through the non-independent transmission medium such as the power line, IEEE 802.11 and wireless (for example, including a power line communication protocol and/or a wireless protocol), the data link layer 80 further includes a home code control sublayer 81 for setting, managing and processing home codes (or domain codes) for logically dividing each individual network. When the data link layer standardized transmission medium is used, a network classification method prescribed in the specification of the corresponding protocol can be employed. Especially, in the case that the individual networks are physically divided by the independent transmission medium such as RS-485, it is advantageous not to form the home code control sublayer 81 Therefore, the home code control sublayer 81 is preferably included in the data link layer 80 determined according to the transmission media. The home code consists of 4 bytes and has a value set by the master device or designated by the user.

According to the application purpose, the physical layer 90 can selectively use the data link layer non-standardized transmission medium, such as the RS-485 91 and the small output RF 92, and the data link layer standardized wire/wireless transmission medium, such as the power line communication 93, IEEE 802.15.4 94, IEEE 802.3 and IEEE 802.11.

Especially, an adapter can be used to embody the physical layer 90 and the data link layer 80 of the network device using the above-described control protocol, which will be explained later.

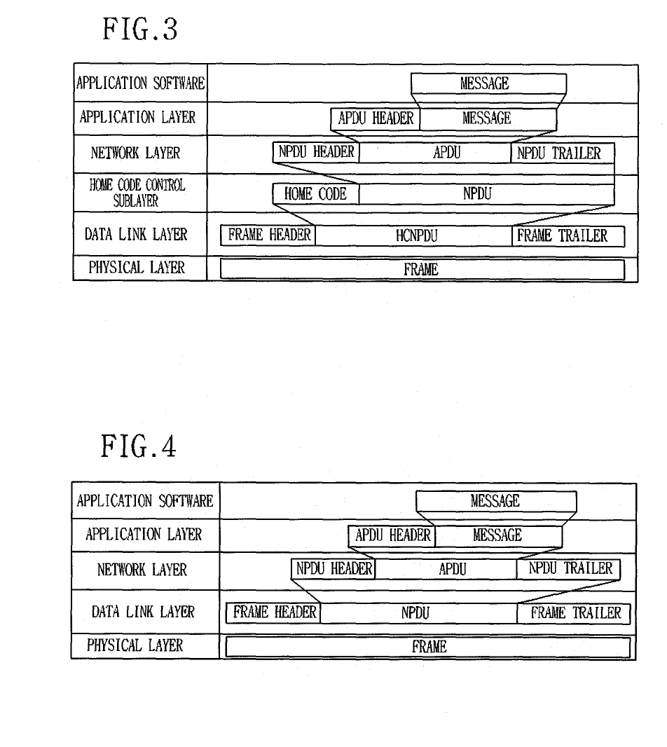

FIGS. 3 and 4 are configuration views illustrating interfaces between the layers of FIG. 2, respectively.

FIG. 3 illustrates the interfaces between the layers when the physical layer 90 is connected to the non-independent transmission medium (namely, the shared transmission medium), and FIG. 4 illustrates the interfaces between the layers when the physical layer 90 is connected to the independent transmission medium (namely, the private line medium).

The home network system 1 adds header and trailer information required in each layer to a protocol data unit (PDU) which is a message from the upper layer, and transfers the resulting message to the lower layer.

As shown in FIGS. 3 and 4, an application layer PDU (APDU) is a data transferred between the application layer 60 and the network layer 70, a network layer PDU (NPDU) is a data transferred between the network layer 70 and the data link layer 80 or the home code control sublayer 81, and a home code control sublayer PDU (HCNPDU) is a data transferred between the network layer 70 and the data link layer 80 (precisely, the home code control sublayer 81). The interface between the data link layer 80 and the physical layer 90 is formed in data frame units. The physical layer 90 transmits and receives data in frame units.

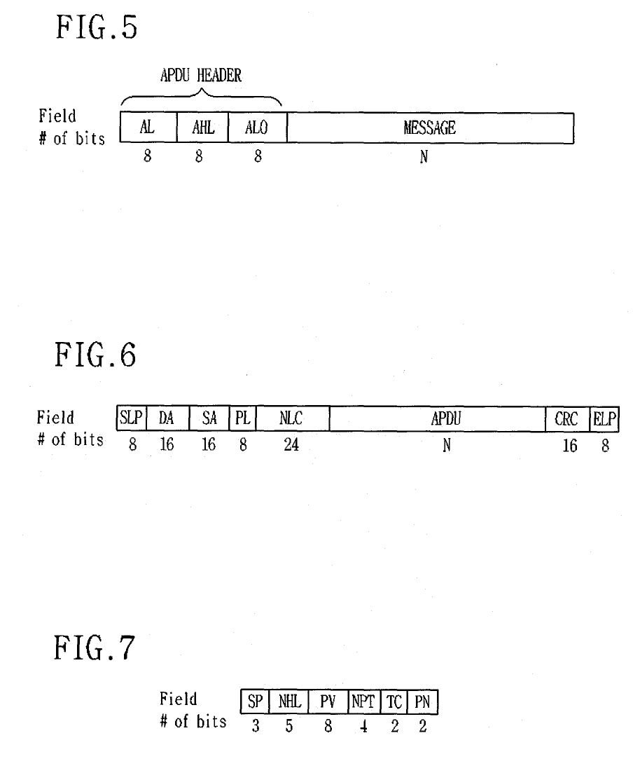

FIGS. 5 to 10 are detailed configuration views illustrating the interfaces of FIGS. 3 and 4, respectively.

FIG. 5 illustrates the APDU of the application layer 60.

An APDU length (AL) field indicates a length of the APDU (length from AL to a message field).

An APDU header length (AHL) field indicates a length of an APDU header (length from AL to AL0). The APDU header of 3 bytes can be extended to 7 bytes. In the control protocol of the present invention, the APDU header can be extended to 7 bytes to encode the message field and change the application protocol. For example, in the case of the APDU header received by the application layer 60 of the network device using version 2.0, the APDU header exceeding 3 bytes is ignored.

An application layer option (AL0) field serves to extend the message set. For example, the AL0 field is set as ‘0’ in version 2.0. If the AL0 field has a different value, message processing is ignored.

The message field serves to process a control message from the user or event information. The message field is formed by the message set classified by the AL0 field.

FIG. 6 illustrates the NPDU of the network layer 70, and FIG. 7 illustrates detailed NLC of the NPDU.

A start of LnCP packet (SLP) field indicates start of a packet and has a value of 0x02.

A destination address (DA) field and a source address (SA) field indicate node addresses of a receiver and a sender of a transmission packet, and have 16 bits, respectively. The most significant 1 bit includes a flag indicating a group address, the succeeding 7 bits include a kind (product code) of a product which is a network device, and the lower 8 bits include a logical address allocated for identification, when the plurality of network managers 20 to 23 of the same kind and the plurality of electric devices 40 to 49 of the same kind exist.

A packet length (PL) field indicates the whole length of the NPDU to be transmitted. The minimum value is 16 bytes and the maximum value is 255 bytes. However, the length of the NPDU that can be processed in the used adapter 35 or 36 may be limited.

A service priority (SP) field gives transmission priority to the transmission messages and consists of 3 bits. Table 2 shows the priority of each transmission message.

In the case that the slave device responds to the request of the master device, the slave device takes the priority of the request messages from the master device.

TABLE 2

| Priority | Value | Application (application layer) |
|---|---|---|
| High | 0 | When urgent message is transmitted |
| Middle | 1 | When normal packet is transmitted |
| | | When event message relating to online or offline state |
| | | change is transmitted |
| Normal | 2 | When notification message for network configuration is |
| | | transmitted |
| | | When normal event message is transmitted |
| Low | 3 | When data is transmitted by download or upload |
| | | mechanism |

An NPDU header length (NHL) field is used to extend an NPDU header (NLC field of SLP). The NPDU header has 9 bytes in non-extension, and can be extended to 16 bytes. For example, in the case of the NPDU header received by the network device using version 2.0 (in non-extension), the NPDU header exceeding 9 bytes is ignored.

A protocol version (PV) field is one byte filed for indicating the version of the applied protocol. The upper 4 bits indicate a version field, and the lower 4 bits indicate a subversion field. The version and the subversion are represented by a hexadecimal number.

A network layer packet type (NPT) field is a 4 bit field for dividing kinds of packets in the network layer 70. The LnCP includes a request packet, a response packet and a notification packet. The NPT field of the master device must be set as the request packet or the notification packet, and the NPT field of the slave device must be set as the response packet or the notification packet. Table 3 shows NPT values by kinds of packets.

TABLE 3

| Value | Description |
|---|---|
| 0 | Request packet |
| 1~3 | Not used |
| 4 | Response packet |
| 5~7 | Not used |
| 8 | Notification packet |
| 9~12 | Not used |
| 13~15 | Reserved value for interface with home code |
| | control sublayer |

A transmission counter (TC) field is a 2 bit field for retransmitting the request packet when the request packet or the response packet is not successfully transmitted due to a communication error of the network layer 70, or for repeatedly transmitting the notification packet to improve the transmission success rate. The receiver can detect the duplicate messages by using the value of the TC field. The value of the TC field is set as ‘1’ in the initial transmission, and increased by ‘1’ in every retransmission or repeated transmission.

Table 4 shows the range of the TC field by the NPT values.

TABLE 4

| Kind of packet | Value (range) |
|---|---|
| Request packet | 1~3 |
| Response | 1 |
| packet | |
| Notification | 1~3 |
| packet | |

A packet number (PN) field consists of 2 bits, detects duplicated packets in the slave device with the TC field, and processes multiple communication cycles in the master device.

When the master device transmits a new packet, the value of the PN field is increased by ‘1’. When the master device retransmits the same packet, the value of the PN field is maintained as it is. If the increased value is ‘4’, the value of the PN field is set as ‘0’. When the slave device transmits the response packet, the slave device copies and uses the value of the PN field of the received request packet. When the slave device transmits the notification packet, the value of the PN field is increased by ‘1’. If the increased value is ‘4’, the value of the PN field is set as ‘0’.

Table 5 shows the range of the PN field by the NPT values.

TABLE 5

| Kind of packet | Value (range) |
|---|---|
| Request packet | 0~3 |
| Response | Copy PN field value of |
| packet | request packet |
| Notification | 0~3 |
| packet | |

An APDU field is a protocol data unit of the application layer 60 transferred between the application layer 60 and the network layer 70. The minimum value of the APDU field is 0 byte and the maximum value thereof is 88 bytes.

A cyclic redundancy check (CRC) field is a 16 bit field for detecting an error of the received packet (from SLP to APDU).

An end of LnCP packet (ELP) field indicates the end of the packet and has a value of 0x03. After the data having the length of the length field of the packet is received, if the ELP field is not detected, this packet is considered as an error packet.

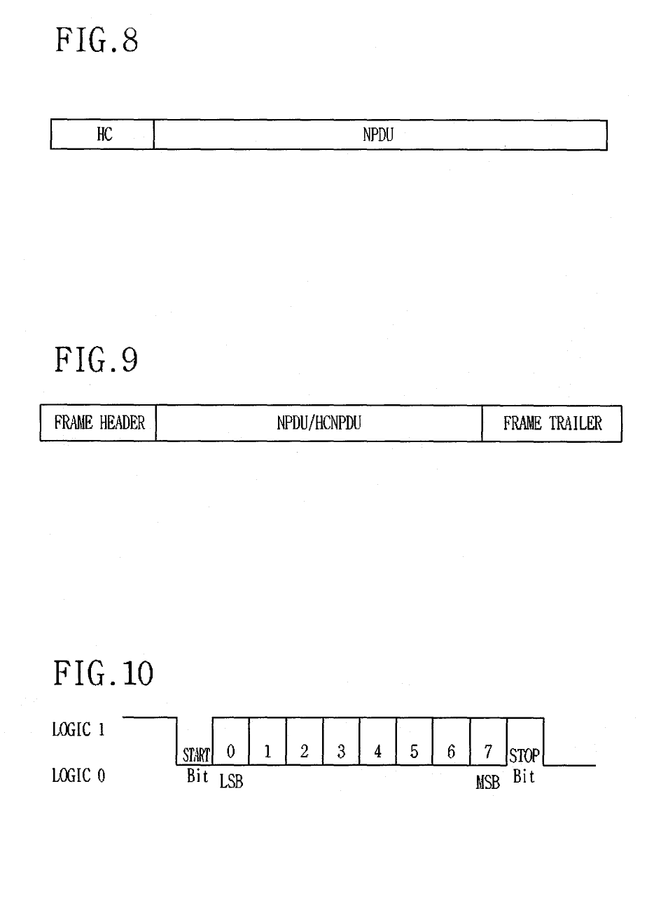

FIG. 8 illustrates the HCNPDU of the home code control sublayer 81.

As depicted in FIG. 8, a home code (HC) field is additionally formed at the upper portion of the NPDU.

The home code consists of 4 bytes and must have a unique value within a line distance of propagating the packet. In addition, the home code information must not be detected through the non-independent transmission medium.

FIG. 9 illustrates a frame of the data link layer 80.

In the data link layer 80 of the control protocol of the present invention, the configuration of a header and a trailer of the frame is changed according to the transmission media. When the data link layer non-standardized transmission medium is used, the header and the trailer of the frame must have a null field. When the standardized transmission medium is used, the header and the trailer of the frame are generated as prescribed by the protocol. NPDU is a data unit transferred from the upper network layer 70, and HCNPDU is a data unit generated by adding, to the front portion of the NPDU, the 4 byte home code used when the physical layer 90 is the non-independent transmission medium, such as the power line or IEEE 802.11.

FIG. 10 illustrates a frame of the physical layer 90.

The physical layer 90 of the control protocol of the present invention transmits and receives the physical signals to the transmission medium. The data link layer non-standardized transmission medium such as RS-485 or small output RF, or the standardized transmission medium such as the power line or IEEE. 802.11 can be used as the physical layer 90. The home network system 1 applied to the LnCP network employs a universal asynchronous receiver and transmitter (UART) frame structure and an RS-232 signal level, so that the network managers 20 to 23 and the electric devices 40 to 49 can interface with the RS-485, the routers 30 and 31 or the adapters 35 and 36. When the devices are connected through a serial bus, the UART controls flow of bit signals on a communication line. In the control protocol, as shown in FIG. 10, the packet from the upper layer is converted into 10 bits of UART frame units, and transferred through the transmission medium. The UART frame includes 1 bit of start bit, 8 bit of data and 1 bit of stop bit, but does not use any parity bit. The UART frame is transferred in the order of the start bit to the stop bit. In the case that the home network system 1 using the control protocol employs the UART, it does not use an additional frame header and frame trailer.

The parameters used in the aforementioned layers will now be explained.

Data types of the parameters explained below are equivalent to any one of the data types of Table 6.

TABLE 6

| Notation | Data type | Description |
|---|---|---|
| char | signed char | 1 byte when data length is not stated |
| uchar | unsigned char | 1 byte when data length is not stated |
| int | signed int | 2 bytes when data length is not stated |
| uint | unsigned int | 2 bytes when data length is not stated |
| long | signed long | 4 bytes when data length is not stated |
| ulong | unsigned long | 4 bytes when data length is not stated |
| string | String | Character string data where last byte |
| | | is NULL |
| FILE | — | Data having file structure |

The application layer 60 generates the message and the APDU by using the information or the command of the user transferred through the application software 50, transfers the message and the APDU to the lower network layer 70, interprets the APDU from the lower network layer 70, and transfers the APDU to the application software 50.

Table 7 shows values of node parameters used in the application layer 60.

TABLE 7

| Name | Type | Description |
|---|---|---|
| AddressReqInt | Constant uint | Time interval of requesting device logical |
| | | address setting to get logical address |
| | | after power on |
| NP_AliveInt | uint | Time interval of notifying online state |
| | | after getting logical address |
| NP_BufferSize | uchar | Buffer size (byte) for containing message |
| SvcTimeOut | constant uint | Time taken for application layer to receive |
| | | NLCompleted primitive, after transferring |
| | | RegMsgSend primitive |
| DLInterval | constant unit | Time interval that download service is |
| | | regarded as failure, if application layer of |
| | | slave device receiving download request |
| | | message does not receive another |
| | | download request message |

The network layer 70 performs the following functions.

First, the network layer 70 performs an address management function, namely, stores its address and destination addresses of the network managers 20 to 23 or the electric devices 40 to 49. Here, the network layer 70 can designate a cluster address by using information and position information of the network managers 20 to 23 or the electric devices 40 to 49 contained in the addresses, and support multicasting and broadcasting communication.

Second, the network layer 70 performs a flow control function, namely, controls flow of the packets by managing the communication cycle.

Third, the network layer 70 performs an error control function. If the network layer 70 does not receive the response packet within a set time, the network layer 70 retransmits the data. The number of retransmission times is limited to maximally 3.

Fourth, the network layer 70 performs a transaction control function, namely, prevents duplicate execution of the same message by detecting the duplicate packets, and controls simultaneous communication cycles.

Fifth, the network layer 70 performs a routing control function, namely, transfers the packets between at least two independent transmission media, and controls flow of the packets to prevent permanent looping between the routers 30 and 31 and the adapters 35 and 36.

The network layer 70 provides the services in communication cycle units. Provided are four communication cycles {1-Request, 1-Response}, {1-Request, Multi-Responses}, {1-Notification} and {Repeated-Notification}.

In the {1-Request, 1-Response} communication cycle, one master device sends one request packet to one slave device, and the slave device transfers one response packet as a response.

In the {1-Request, Multi-Responses} communication cycle, one master device sends one request packet to the plurality of slave devices, and each slave device sends the response packet to the request packet one by one.

In the {1-Notification} communication cycle, the (master or slave) device sends one notification packet to one or multiple (master or slave) devices, and directly ends the communication.

In the {Repeated-Notification} communication cycle, in order to obtain transmission reliability of the {1-Notification} communication cycle, the device repeatedly transmits the same packet and ends the communication.

Table 8 shows the relations of the aforementioned communication cycles, the packet types and the transmission services (or NL services).

TABLE 8

| Communication cycle | Packet type | NL service |
|---|---|---|
| {1-Request, | Request | Acknowledged(0) |
| 1-Response} | packet-Response | |
| | packet | |
| {1-Request, | Request | Acknowledged(0) |
| Multi-Responses} | packet-Response | |
| | packet | |
| {1-Notification} | Notification packet | Non-Acknowledged(1) |
| {Repeated-Notification} | Notification packet | Repeated-Notification(2) |

Table 9 shows values of node parameters used in the network layer 70.

TABLE 9

| Name | Type | Description |
|---|---|---|
| ProductCode | uchar | Product code |
| NP_LogicalAddress | uchar | Logical address |
| NP_ClusterCode | uchar | Cluster code |
| NP_HomeCode | ulong | Home code |
| SendRetries | uchar | Number of maximum retransmission times |
| | | of request packet in acknowledged service, |
| | | or number of repeated transmission times |
| | | in repeated notification service |
| SendTimeOut | constant | Time taken for network layer to receive |
| | uint | DLLCompleted primitive, after |
| | | transferring NPDU to data link layer |
| ResDelayTime | uint | Random delay time before response packet |
| | | is transferred by slave which received |
| | | request packet, when acknowledged |
| | | transmission service with group address |
| | | is running |
| RepeaterDelayTime | constant | Maximum time permitted for normal |
| | uint | packet to be sent from sender to receiver, |
| | | when network is normally functioning |
| DupElapsedTime | constant | Minimum time interval between request |
| | uint | packets which secures every packet |
| | | independence, when slave receives request |
| | | packets continuously from same master |

The data link layer 80 prescribes the MAC function for accessing the shared transmission medium. When the data link layer non-standardized transmission medium such as RS-485 is used, the p-DCSMA is used as the MAC protocol. When the standardized transmission medium such as the power line or IEEE 802.11 is used, the prescriptions of the specification of the corresponding protocol are applied.

Table 10 shows values of node parameters used in the data link layer 80 using the UART frame. Each parameter time is set in the presumption that a transmission rate of the physical layer 90 is 4800 bps. Here, one information unit time (IUT) is 2.1 ms.

TABLE 10

| Name | Type | Description |
|---|---|---|
| Frame | constant | Maximum time interval permitted |
| permitted | uchar | between UART frames when |
| time interval | FrameTime | receiving packets |
| | Out | |
| Maximum | constant | Maximum time interval permitted |
| frame | uchar | between UART frames when |
| permitted time | MaxFrameInterval | sending packets |
| interval | | |
| Minimum | uint | Minimum time interval permitted |
| packet | MinPktInterval | between two consecutive packets |
| Permitted time | | transmitted on medium in packet |
| interval | | transmission. Time for transferring |
| | | packet received by data link layer |
| | | to application layer and finishing |
| | | packet processing must be smaller |
| | | than this value. |
| Backoff retry | constant | Maximum repeat times of MAC |
| times | uchar | algorithm due to arbitration failure |
| | BackOffRetries | or data collision |
| Maximum | constant | Permitted execution time (ms) of |
| transmission | uint | MAC algorithm |
| permitted time | MACExecTime | |
| Busy check | constant | Time for detecting medium status |
| time | uchar | (busy or idle) |
| | BusyCheckTime | |
| Transmission | uint | Standby time for transmission |
| delay | RandomDelayTime | when medium is in idle status. |
| time | | Randomly decided within |
| | | competitive window range selected |
| | | by SvcPriority value |

Table 11 shows values of node parameters used in the physical layer 90.

TABLE 11

| Name | Type | Description |
|---|---|---|
| Communication | Unit | Communication speed of UART (ex. |
| speed | NP_bps | 96000 bps, 19200 bps) |

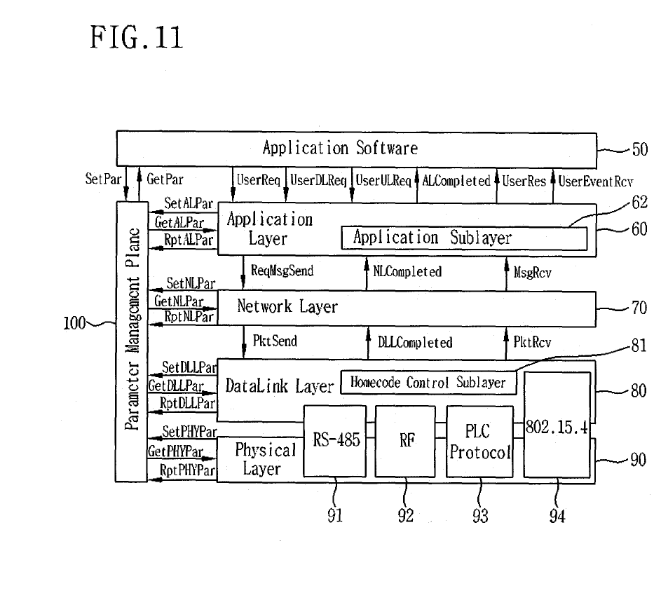

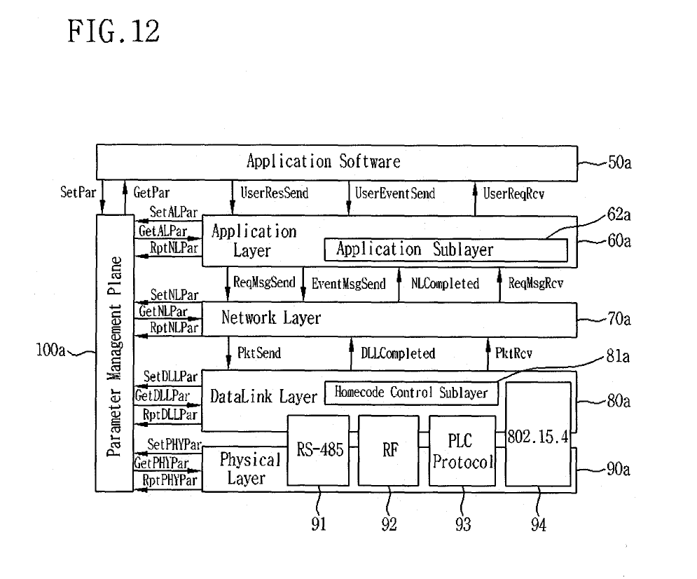

FIGS. 11 and 12 are configuration views illustrating primitives for transmitting data exchanged between the layers, respectively.

FIG. 11 illustrates transfer of the primitives between the layers of the master device.

As shown in FIG. 11, the primitives between the application software 50 and the application layer 60 include UserReq, UserDLReq, UserULReq, ALCompleted, UserRes and UserEventRcv.

The user request primitive UserReq, which is a service request primitive with a single communication cycle transferred from the application software 50 of the master device, is used for controlling or monitoring. The user request primitive UserReq includes constitutional elements of Table 12.

TABLE 12

| Name | Type | Description |
|---|---|---|
| Application | ulong | Application service code of application |
| service | ALSvcCode | layer, combination of product code and |
| Code | | command code |
| Request | uchar* | Request message constructed by |
| message | *ReqMsg | command code and input arguments |
| Length of | uchar | Byte data length of request message |
| request | ReqMsgLength | |
| message | | |
| Designation | uint | Address of receiver device |
| address | DstAddress | |
| Application | uchar | Transmission service types |
| layer | ALService | 0: Request-response-message |
| service | | 1: Request-message-only |
| | | 2: Repeated-message |
| | | 3: Event-message-only |
| Timeout | uint TimeOut | When ALService is |
| | | Request-response-message, time (ms) |
| | | taken for master device to wait for |
| | | response packet after sending request |
| | | packet, or when ALService is |
| | | Repeated-message, time interval (ms) |
| | | between consecutive messages. |
| | | Appropriate value for each |
| | | communication medium speed is used. |
| Service | uchar | Transmission priority in data link layer |
| priority | SvcPriority | |

In the application layer service (AL service), Request-response-message means combination of a request message and a response message. The master device transmits the request message, and the slave device receiving the request message always transmits the response message. Request-message-only means a singly-provided request message. The slave device receiving the request message does not transmit a response message. Repeated-message means a singly-provided consecutive request message or event message. The slave device does not transmit a response message. Event-message-only means a singly-provided event message. The slave device does not transmit a response message.

The user download request primitive UserDLReq, which is a download service request primitive transferred from the application software 50 of the master device, includes constitutional elements of Table 13.

TABLE 13

| Name | Type | Description |
|---|---|---|
| Application | ulong | Application service code of |
| service | ALSvcCode | application layer, combination of |
| code | | product code and command code |
| Download file | FILE* | Data file to be downloaded |
| Application | uchar | Transmission service type fixed to |
| layer | ALService = 0 | Request-response-message(0) |
| service | | |
| Destination | uint | Address of receiver device |
| address | DstAddress | |
| Timeout | uint TimeOut | Time taken for network manager to |
| | | wait for response packet after |
| | | sending request packet |
| Service | uchar | Transmission priority in data link |
| priority | SvcPriority | layer fixed to ‘1’ |

The user upload request primitive UserULReq, which is an upload service request primitive transferred from the application software 50 of the master device, includes constitutional elements of Table 14.

TABLE 14

| Name | Type | Description |
|---|---|---|
| Application | ulong | Application service code of application |
| service | ALSvcCode | layer, combination of product code and |
| code | | command code |
| Upload file | FILE* | File name for storing uploaded data |
| | *UploadFile | |
| Application | uchar | Transmission service type fixed to |
| layer service | ALService | Request-response-message(0) |
| Destination | uint | Address of receiver device |
| address | DstAddress | |
| Timeout | uint | Time taken for master device to wait for |
| | TimeOut | response packet after sending request |
| | | packet |
| Service priority | uchar | Transmission priority in data link layer |
| | SvcPriority | fixed to ‘1’ |

The user response primitive UserRes, which is a primitive for transferring a service execution result of the master device to the application software 50, includes constitutional elements of Table 15.

TABLE 15

| Name | Type | Description |
|---|---|---|
| Application | ulong | Application service code of |
| service | ALSvcCode | application layer, combination of |
| Code | | product code and command code |
| Response | uchar* | Response message constructed by |
| message | ResMsg | command code and input arguments |
| Length of | uchar | Byte data length of response |
| response | ResMsgLength | message |
| Message | | |
| Source | uint | Address of sender device |
| address | SrcAddress | |

The user event receiving primitive UserEventRcv, which is an event service primitive transferred to the application software 50 of the master device, includes constitutional elements of Table 16.

TABLE 16

| Name | Type | Description |
|---|---|---|
| Application | ALSvcCode | Application service code of |
| service | | application layer, combination of |
| Code | | product code, command code and |
| | | event code |
| Event | uchar* | Event message from slave device |
| message | EventMsg | |
| Length of | uchar | Byte data length of response |
| event | EventMsgLength | message |
| Message | | |
| Source | uint | Address of sender device |
| address | SrcAddress | |

The application layer completion primitive ALCompleted, which is a primitive for transferring an execution result of the application layer 60 of the master device to the application software 50, includes constitutional elements of Table 17.

TABLE 17

| Name | Type | Description |
|---|---|---|
| Application | ulong | Application service code of application |
| service | ALSvcCode | layer, combination of product code and |
| code | | command code |
| Service | uchar | If application layer finishes requested |
| result | ALResult | service successfully, the value will be |
| | | SERVICE_OK(1); if not, it will be |
| | | SERVICE_FAILED(0) |
| Failure | uchar | When ALResult is SERVICE_FAILED, |
| reason code | ALFailCode | classified value of reason of failure |

Still referring to FIG. 11, the primitives between the application layer 60 and the network layer 70 include ReqMsgSend, NLCompleted and MsgRev.

The request message sending primitive ReqMsgSend, which is a primitive for transferring a message from the application layer 60 of the master device to the network layer 70, includes constitutional elements of Table 18.

TABLE 18

| Name | Type | Description |
|---|---|---|
| Communication | ulong CycleID | ID number of communication |
| cycle | | cycle in master device |
| identifier | | |
| Request message | uchar* | APDU including request message |
| | ReqAPDU | created in application layer of |
| | | master device |
| Length of request | uchar | Byte data length of APDU |
| message | APDULength | |
| Destination | uint DstAddress | Address of receiver device |
| address | | |
| Source address | uint SrcAddress | Address of sender device |
| Network layer | uchar | Master device communication |
| service | NLService | cycle service types |
| | | 0: Acknowledged (communication |
| | | cycle of request and response) |
| | | 1: Non-acknowledged (request |
| | | command which does not wait for |
| | | response) |
| | | 2: Repeated-notification |
| | | (repeated transmission of event) |
| Response timeout | uchar | When NL service is chosen as |
| | responseTimeOut | Acknowledged, time (ms) taken |
| | | for master device to wait for |
| | | response packet, after sending |
| | | request packet |
| Transmission | uint | When NL service is chosen as |
| time interval | RepNotiInt | Repeated-notification, time |
| between repeated | | interval (ms) between |
| notification | | consecutive notification packets |
| packets | | |
| Service priority | uchar | Transmission priority of request |
| | SvcPriority | message |

Here, the communication cycle identifier CycleID is generated by combining the application service code ALSvcCode with the node address of the receiver device.

The message receiving primitive MsgRcv, which is a primitive for transferring a packet from the network layer 70 of the master device to the application layer 60, includes constitutional elements of Table 19.

TABLE 19

| Name | Type | Description |
|---|---|---|
| Communication | ulong CycleID | ID number of communication cycle |
| cycle | | in master device |
| Identifier | | |
| Event response | uchar* | APDU to be transferred to |
| message | ResEventAPDU | application layer (response or event |
| | | message) |
| Length of event | uchar | Byte data length of APDU |
| response | APDULength | |
| message | | |
| Destination | uint | Address of receiver device |
| address | DstAddress | |
| Source address | uint | Address of sender device |
| | SrcAddress | |

The structure of the communication cycle identifier CycleID will be explained later.

The network layer completion primitive NLCompleted, which is a primitive for notifying a packet processing status from the network layer 70 to the application layer 60, includes constitutional elements of Table 20.

TABLE 20

| Name | Type | Description |
|---|---|---|
| Communication | ulong CycleID | ID number of communication cycle |
| cycle identifier | | in master device |
| Transmission | uchar | If communication cycle is |
| result | NLResult | completed successfully, this value |
| | | will be CYCLE_OK(1); if not, |
| | | it will be CYCLE_FAILED(0) |
| Failure reason | uchar | When NLResult is |
| code | NLFailCode | CYCLE_FAILED, classified value |
| | | of reason of failure |
| Number of | uchar | When NLResult is CYCLE_OK, |
| retransmission | NLSuccessCode | number of retransmission times |
| times | | |

As shown in FIG. 11, the primitives between the network layer 70 and the data link layer 80 include PktSend, PktRcv and DLLCompleted.

The packet sending primitive PktSend, which is a primitive for transferring a packet from the network layer 70 to the data link layer 80, includes constitutional elements of Table 21.

TABLE 21

| Name | Type | Description |
|---|---|---|
| Packet | uchar* | Packet of network layer |
| | NPDU/HCNPDU | |
| Length of | uchar | Byte data length of |
| packet | NPDULength | NPDU/HCNPDU |
| Service | uchar SvcPriority | Transmission priority |
| priority | | |

The packet receiving primitive PktRcv, which is a primitive for transferring a packet from the data link layer 80 to the network layer 70, includes constitutional elements of Table 22.

TABLE 22

| Name | Type | Description |
|---|---|---|
| Packet | uchar* NPDU | Packet of network layer |
| Length of | uchar | Byte data length of NPDU |
| packet | NPDULength | |

The data link layer completion primitive DLLCompleted, which is a primitive for notifying a packet transmission result from the data link layer 80 to the network layer 70, includes constitutional elements of Table 23.

TABLE 23

| Name | Type | Description |
|---|---|---|
| Packet | uchar | Packet transmission result, if packet |
| transmission | DLLResult | transmission process is completed |
| result | | successfully, the result is SEND_OK(1); |
| | | if not, it will be SEND_FAILED(0) |
| Transmission | uchar | When DLLResult is SEND_FAILED(0), |
| failure | DLLFailCode | classified value of reason of failure |
| reason | | |

At last, the primitives between the data link layer 80 and the physical layer 90 include FrameSend, FrameRcv and RptLineStatus.

The frame sending primitive FrameSend, which is a primitive for transferring an one-byte data from the data link layer 80 to the physical layer 90, includes constitutional elements of Table 24.

TABLE 24

| Name | Type | Description |
|---|---|---|
| Byte | uchar | Transferred 1-byte |
| | UART_byte | data |

The frame receiving primitive FrameRcv, which is a primitive for transferring an one-byte data from the physical layer 90 to the data link layer 80, includes constitutional elements of Table 25.

TABLE 25

| Name | Type | Description |
|---|---|---|
| Byte | uchar | 1-byte data to be |
| | UART_byte | transferred |

The line status transferring primitive RptLineStatus, which is a primitive for representing a line status transferred to the data link layer 80, includes constitutional elements of Table 26.

TABLE 26

| Name | Type | Description |
|---|---|---|
| Line | uchar | If UART frame is detected on line, |
| status | LineStatus | LINE_BUSY(1) will be transferred; otherwise, |
| | | LINE_IDLE(0) will be transferred. |

FIG. 12 illustrates transfer of the primitives between the layers of the slave device.

The primitives between the application software 50a and the application layer 60a include UserReqRcv, UserResSend and UserEventSend.

The user request receiving primitive UserReqRcv, which is a primitive for transferring a request message (including download and upload) from the master device to the application software 50a of the slave device, includes constitutional elements of Table 27.

TABLE 27

| Name | Type | Description |
|---|---|---|
| Application | ulong | Service code of application layer, |
| service | ALSvcCode | combination of product code and |
| code | | command code |
| Request data | uchar* | Data contained in request message |
| | ReqData | from master device |
| Length of | uchar | Length (byte) of request data |
| request data | ReqDataLength | |
| Source address | uint SrcAddress | Address of sender device |
| Duplication | uchar | If there is no duplicate packet, it will |
| check | Duplicatecheck | be NORMAL_PKT(1); if not, it will |
| | | be DUPLICATED_PKT(0) |

The user response sending primitive UserResSend, which is a primitive for transferring a response message to a request message of the master device to the application layer 60a of the slave device, includes constitutional elements of Table 28.

TABLE 28

| Name | Type | Description |
|---|---|---|
| Application | ulong | Service code of application layer, |
| service | ALSvcCode | combination of product code and |
| code | | command code |
| Response | uchar* | Data contained in response message |
| data | ResData | to be sent to master device |
| Length of | uchar | Byte length of ResData |
| response | ResDataLength | |
| data | | |

The user event sending primitive UserEventSend, which is a primitive for transferring, to the application layer 60a, a status variable of an event message of the slave device intended to be transmitted to the master device, includes constitutional elements of Table 29.

TABLE 29

| Name | Type | Description |
|---|---|---|
| Application | uchar | Service code of application layer, |
| service | ALSvcCode | combination of product code, |
| code | | command code and event code |
| Application | uchar | Transmission service types |
| layer service | ALService | 2: Repeated-message, |
| | | 3. Event-message-only |
| Event message | uchar | Length of event message |
| length | EventLength | |
| Event data | uchar | Value of event message |
| | EventData | |
| Service priority | uchar | Transmission priority of event |
| | SvcPriority | message |
| Repeated | uint | When NLservice is chosen as |
| notification | RepNotiInt | Repeated-notification, time interval |
| interval | | between consecutive notification |
| | | packets |

Still referring to FIG. 12, the primitives between the application layer 60a and the network layer 70a include ReqMsgRcv, ResMsgSend, EventMsgSend and NLCompleted.

The request message receiving primitive ReqMsgRcv, which is a primitive for transferring a received request message from the network layer 70a to the application layer 60a, includes constitutional elements of Table 30.

TABLE 30

| Name | Type | Description |
|---|---|---|
| Request | uchar* | APDU to be transferred to application |
| message | ReqAPDU | layer |
| Length of | uchar | Byte data length of APDU |
| request | APDULength | |
| Message | | |
| Destination | uint | Address of receiver device |
| address | DstAddress | |
| Source | uint | Address of sender device |
| address | SrcAddress | |
| Network layer | uchar | Communication cycle service types |
| Service | NLService | of slave device |
| | | 0: Acknowledged, 1: |
| | | Non-acknowledged |
| Duplicate | uchar | If there is no duplicate packet, it will |
| packet | DuplicateCheck | be NORMAL_PKT(1); if not, it will |
| check result | | be DUPLICATED_PKT(0) |

The response message sending primitive ResMsgSend, which is a primitive for transferring a response message from the application layer 60a to the network layer 70a, includes constitutional elements of Table 31.

TABLE 31

| Name | Type | Description |
|---|---|---|
| Communication | ulong | ID number of communication cycle |
| cycle identifier | CycleID | in slave device |
| Response | uchar* | APDU including response message |
| message | ResAPDU | created in application layer of slave |
| | | device |
| Length of | uchar | Byte data length of APDU |
| response | APDULength | |
| message | | |

The event message sending primitive EventMsgSend, which is a primitive for transferring an event message from the application layer 60a to the network layer 70a, includes constitutional elements of Table 32.

TABLE 32

| Name | Type | Description |
|---|---|---|
| Communication | ulong | ID number of communication cycle |
| Cycle identifier | CycleID | in slave device |
| Event message | uchar* | APDU including event message |
| | EventAPDU | created in application layer of slave |
| | | device |
| Length of event | uchar | Byte data length of APDU |
| message | APDULength | |
| Destination | uint | Address of receiver device |
| address | DstAddress | |
| Source address | uint | Address of sender device |
| | SrcAddress | |
| Network layer | uchar | Transmission services in network |
| service | NLService | layer 1: Non-acknowledged, 2: |
| | | Repeated-notification |
| Transmission | uchar | When the NLService is chosen as |
| interval | RepNotiInt | Repeated-notification, Time interval |
| between | | (ms) between two consecutive |
| repeated | | notification packets |
| notification | | |
| messages | | |
| Service priority | uchar | Transmission priority of event |
| | SvcPriority | message |

The network layer completion primitive NLCompleted, which is a primitive for notifying a packet processing status from the network layer 70a to the application layer 60a, includes constitutional elements of Table 33.

TABLE 33

| Name | Type | Description |
|---|---|---|
| Communication | ulong CycleID | ID number of communication cycle |
| cycle identifier | | in slave device |
| Transmission | uchar | If communication cycle is |
| result | NLResult | completed successfully, the value |
| | | will be CYCLE_OK(1); |
| | | otherwise, it will be |
| | | CYCLE_FAILED(0) |
| Failure reason | uchar | When NLResult is |
| code | NLFailCode | CYCLE_FAILED, classified value |
| | | of reason of failure |
| Number of | uchar | When NLResult is CYCLE_OK, |
| retransmission | NLSuccessCode | number of retransmission times |
| times | | |

Thereafter, the primitives between the network layer 70a and the data link layer 80a of the slave device and the primitives between the data link layer 80a and the physical layer 90a of the slave device are used in the same manner as the primitives of the master device of FIG. 11.

The parameter management planes 100 and 100a set, read or acquire values of parameters as shown in Table 34, by using the application layers 60 and 60a, the network layers 70 and 70a, the data link layers 80 and 80a, the physical layers 90 and 90a, and the corresponding primitives.

TABLE 34

| Layer | Parameter |
|---|---|
| Application | AddressReqInt, NP_AliveInt, SvcTimeOut, |
| layer | NP_BufferSize |
| Network layer | NP_LogicalAddress, NP_ClusterCode, |
| | NP_HomeCode, SendRetries |
| Data link layer | MinPktInterval |
| Physical layer | NP_bps |

In addition, the parameter management planes 100 and 100a can set or read the parameters used in each layer.

Table 35 shows the parameters used in the parameter management planes 100 and 100a.

TABLE 35

| Name | Type | Description |
|---|---|---|
| Parameter | const uint | Standby time (ms) for receiving RptALPar |
| timeout | ParTimeOut | (or RptNLPar, RptDLLPar, RptPHYPar), |
| | | after transferring GetALPar (or GetNLPar, |
| | | GetDLLPar or GetPHYPar) to each layer |

Parameter setting primitives SetALPar, SetNLPar, SetDLLPar and SetPHYPar for setting predetermined parameter values, parameter getting primitives GetALPar, GetNLPar, GetDLLPar and GetPHYPar for getting predetermined parameter values, and parameter transferring primitives RptALPar, RptNLPar, RptDLLPar and RptPHYPar for transferring predetermined parameter values to correspond to the parameter getting primitives GetALPar, GetNLPar, GetDLLPar and GetPHYPar are used between the application layers 60 and 60a, the network layers 70 and 70a, the data link layers 80 and 80a and the physical layers 90 and 90a, and the parameter management planes 100 and 100a.

The parameter setting primitives SetALPar, SetNLPar, SetDLLPar and SetPHYPar are primitives for setting node parameter values of each layer, the parameter getting primitives GetALPar, GetNLPar, GetDLLPar and GetPHYPar are primitives for enabling the parameter management planes 100 and 100a to read the node parameter values of each layer, and the parameter transferring primitives RptALPar, RptNLPar, RptDLLPar and RptPHYPar are primitives for transferring the node parameter values by the requests of the parameter management planes 100 and 100a.

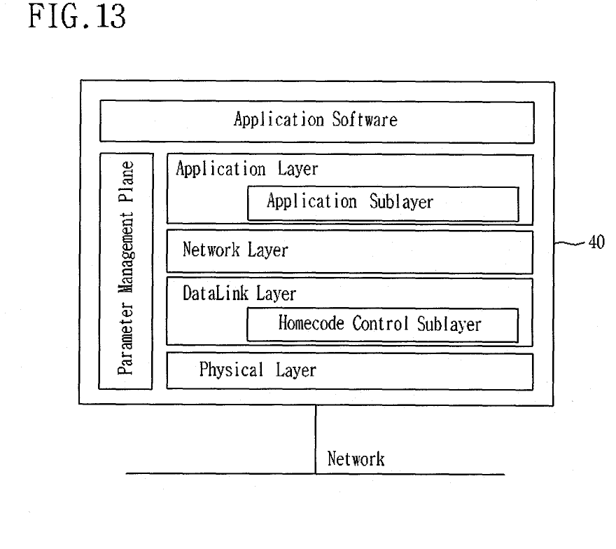

FIG. 13 is a configuration view illustrating the network device to which the control protocol is applied in accordance with the present invention. The electric device 40 is exemplified as the network device of FIG. 13. However, the network device includes the full network device, such as the electric device and the network manager, connected directly to the network (for example, the bus network RS-485, RF network, PLC network, etc.) for performing communication.

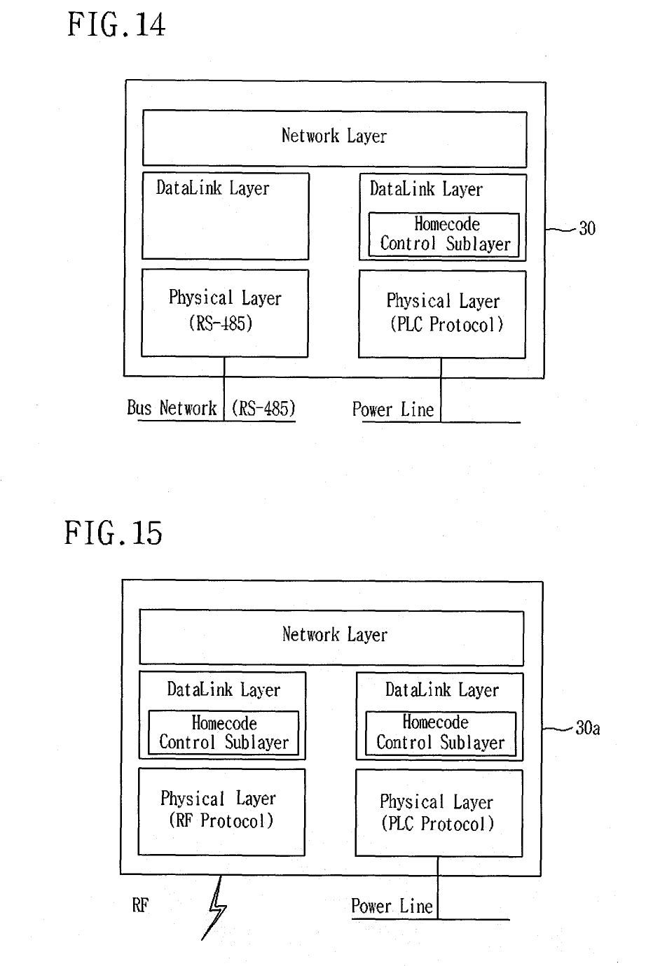

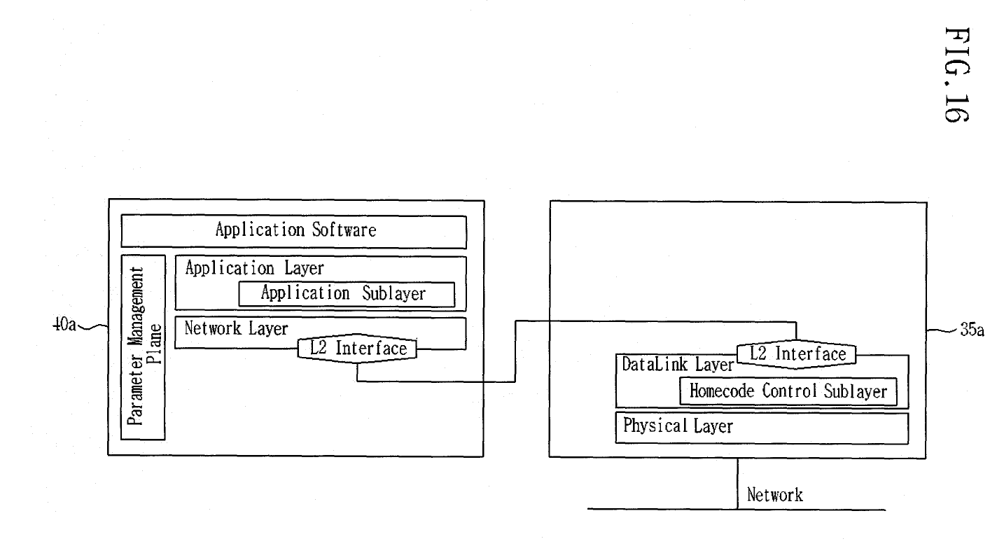

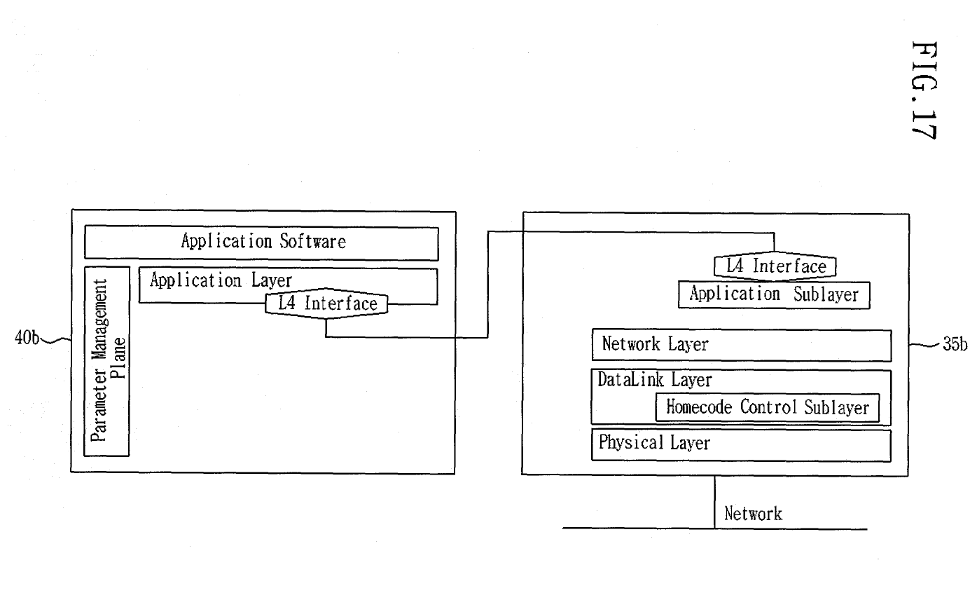

FIGS. 14 and 15 illustrate examples of the routers 30 and 31 of FIG. 1.

FIG. 14 illustrates one example of the router 30 of FIG. 1. The router 30 connects the RS-485 network which is the bus network to the power line communication, includes the home code control sublayer for the power line communication, and uses one home code. The router 30, which is the device for transmitting data between different networks, may not have the application layer.

FIG. 15 illustrates a router 30a for connecting the RF network to the power line communication. The router 30a can use the same or different home codes for the RF network and the power line communication.

FIGS. 16 and 17 illustrate examples of the adapters 35 and 36 of FIG. 1.

As illustrated in FIG. 16, when an electric device 40a cannot be connected directly to the network, the electric device 40a performs functions over a network layer, and an adapter 35a performs functions below a data link layer. Here, the full device of FIG. 13 is constructed as the combination of the electric device 40a and the adapter 35a, and a communication module is disconnected from the electric device 40a. That is, the network device is embodied as the combination of a product which is the electric device 40a and a communication modem which is the adapter 35a, and an L2 interface is formed therebetween.

As shown in FIG. 17, when an electric device 40b cannot be connected directly to the network, an electric device 40b performs functions over an application layer, and an adapter 35b includes an application sublayer and performs functions below a network layer. The full device of FIG. 13 is constructed as the combination of the electric device 40b and the adapter 35b, and a communication module is disconnected from the electric device 40b. That is, the network device is embodied as the combination of a product which is the electric device 40b and a communication modem which is the adapter 35b, and an L4 interface is formed therebetween. When the adapter 35b is connected to the electric device 40b, the application sublayer of the adapter 35b acquires and stores product information, and processes the request of the master device afterwards according to the prestored information without making a request to the electric device 40b.

In FIGS. 16 and 17, the electric devices 40a and 40b and the adapters 35a and 35b preferably interface with each other according to asynchronous serial communication such as the UART or RS-232. The L2 and L4 interfaces are prescribed according to the adapters 35a and 35b. One example of the L4 interface will now be explained.

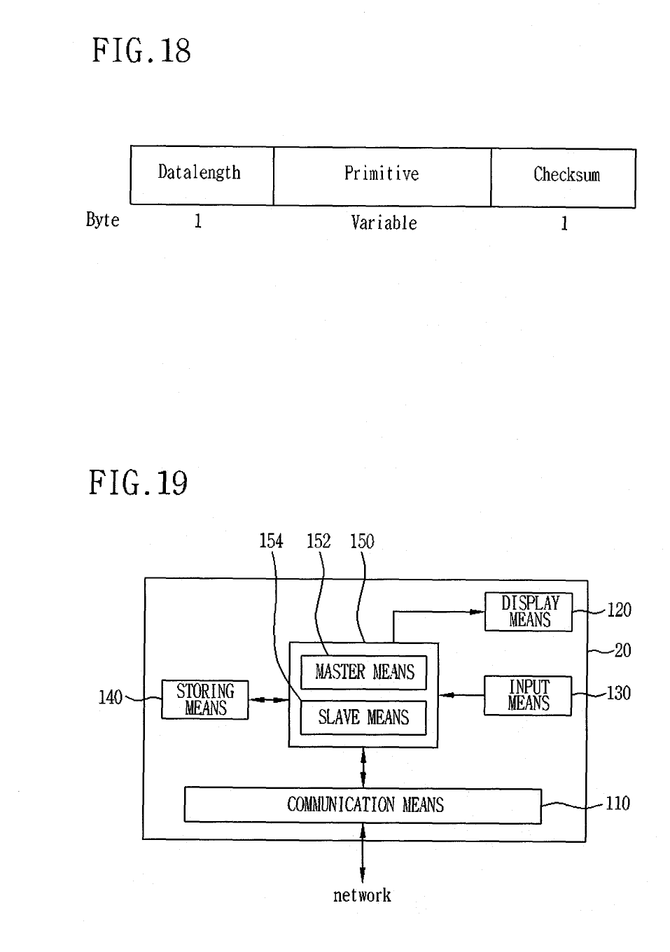

FIG. 18 illustrates a basic structure of a transmission/reception data used in the L4 interface. A Datalength field preceding a primitive field indicates the whole primitive length. A Checksum (1 byte, Sum(Datalength˜Primitive) XOR 0x55) field follows the primitive field. The primitive field is interposed between the Datalength field and the Checksum field.

The L4 interface, which is the communication interface between the electric device 40b and the adapter 35b, complies with the following standard. Table 36 shows the processing standard for the data transmitted from the adapter 35b to the electric device 40b, and Table 37 shows the processing standard for the data transmitted from the electric device 40b to the adapter 35b.

TABLE 36

| Items | Development standard |
|---|---|
| 1 | If 200 ms elapses in data reception, received data is ignored. |
| 2 | If Datalength is larger than maximum receivable buffer size, |
| | received data is ignored. |
| 3 | If Checksum error occurs, received data is ignored. |
| 4 | While received data is processed (before response message is |
| | transmitted), data is not received. |

TABLE 37

| Item | Development standard |
|---|---|
| 1 | Interval between transmitted bytes must be below 200 ms (use |
| | interrupt in UART transmission). |

Table 38 shows kinds of primitives transmitted and received between the electric device 40b and the adapter 35b.

TABLE 38

| | Primitive | |
|---|---|---|
| Primitive name | ID | Description |
| L4ResSend | 180 | Transfer response message from electric |
| | | device to adapter |
| L4ReqRcv | 181 | Transfer request message from adapter to |
| | | electric device |
| L4EventSend | 182 | Transfer event message from electric |
| | | device to adapter |
| L4AdapReqSend | 190 | Transfer adapter-related request message |
| | | from electric device to adapter |
| L4AdapResRcv | 191 | Transfer adapter-related response message |
| | | from adapter to electric device (need not |
| | | to be embodied in product) |

Tables 39 to 43 shows the detailed structures of each primitive.

Table 39 shows the structure of the L4ResSend primitive.

TABLE 39

| Field | Length | Description |
|---|---|---|
| Primitive ID | 1 byte | Fixed to 0xB4 (180) |
| AlSvcCode | 4 bytes | Service code of application layer, combination |
| | | of product code and command code |
| ResDataLength | 1 byte | Byte length of response data |
| ResData | n bytes | Response message (containing command |
| | | code and arguments) |

Table 40 shows the structure of the L4ReqRcv primitive.

TABLE 40

| Field | Length | Description |
|---|---|---|
| Primitive ID | 1 byte | Fixed to 0xB5 (181) |
| AlSvcCode | 4 bytes | Service code of application layer, |
| | | combination of product code and |
| | | command code |
| SrcAddress | 2 bytes | Address of request sender |
| DuplicateCheck | 1 byte | Duplication check (0: Duplicated packets, 1: |
| | | Normal) |
| ReqDataLength | 1 byte | Byte length of request data |
| ReqData | n bytes | Request message (containing command code |
| | | and arguments) |

Table 41 shows the structure of the L4EventSend primitive.

TABLE 41

| Field | Length | Description |
|---|---|---|
| Primitive ID | 1 byte | Fixed to 0xB6 (182) |
| AlSvcCode | 4 bytes | Service code of application layer, |
| | | combination of product code and command |
| | | code |
| AlService | 1 byte | Transmission service types (2: Repeated |
| | | message, 3: Event message only) |
| SvcPriority | 1 bytes | Transmission priority (0: High, 1: Medium |
| | | high, 2: Medium low, 3: Low) |
| RepNotiInt | 2 bytes | When AlService is Repeated message, |
| | | interval between repeated messages. (unit = |
| | | mSec) |
| CurrentState | 1 byte | Status variable of event message |
| EventDataLength | 1 byte | Byte length of event data |
| EventData | n bytes | Event message (including command code, |
| | | event code and event value) |

Table 42 shows the structure of the L4AdapReqSend primitive.

TABLE 42

| Field | Length | Description |
|---|---|---|
| Primitive ID | 1 byte | Fixed to 0xBE (190) |
| AlSvcCode | 4 bytes | Service code of application layer, combination |
| | | of product code and command code |
| DstAddress | 2 bytes | Address of receiver |
| AlService | 1 byte | Transmission service type (1: |
| | | Non-acknowledged) |
| SvcPriority | 1 byte | Transmission priority (0: High, 1: Medium |
| | | high, 2: Medium low, 3: Low) |
| TimeOut | 2 bytes | Time taken to wait for response packet, after |
| | | sending request message |
| | | (unit = mSec) |
| ReqDataLength | 1 byte | Byte length of AdapReqData |
| AdapReqData | n bytes | Request message for adapter (including |
| | | command code and arguments) |

Table 43 shows the structure of the L4AdapResRcv primitive.

TABLE 43

| Field | Length | Description |
|---|---|---|
| Primitive ID | 1 byte | Fixed to 0xBF (191) |
| AlSvcCode | 4 bytes | Service code of application layer, combination |
| | | of product code and command code |
| SrcAddress | 2 bytes | Address currently set in adapter |
| ResDataLength | 1 byte | Byte length of AdapResData |
| AdapReqData | n bytes | Request message for adapter (including |
| | | command code and arguments) |

FIG. 19 is a configuration view illustrating the network manager 20 which is the network device in accordance with the present invention. Referring to FIG. 19, the network manager 20 (the other network managers 21, 22 and 23 have the same configuration) includes a communication means 110 connected to the network, for performing communication, a display means 120 for displaying predetermined information or state, an input means 130 for acquiring a command from the user, a storing means 140, and a control device 150 consisting of a master means 152 for controlling the operations of the other network managers and/or the slave devices (the electric devices 40 to 49 mentioned above, etc.), or monitoring the status thereof, and a slave means 154 having a function of responding to the requests of the other network managers, and a function of providing information on the status change of the network manager 20. Here, the master means 152 and the slave means 154 can be provided as physically divided independent means (also logically divided independent means), or one physical means but logically divided independent means.

The network manager 20 manages the information on all the network devices of the network, and provides the network service to the user. The network manager 20 manages a homenet profile consisting of a set of device profiles containing information on the individual network devices connected to the network. The network manager 20 performs a network configuration work for setting the operation environment of all the network devices connected to the network. After finishing the network configuration work, the network manager 20 updates the homenet profile if the device information is changed.

The network configuration work is started after power is applied to the electric devices 40 to 49 and the network manager 20, and performed through the request-response messages and the event messages between the network manager 20 and each electric device 40 to 49. After the network configuration work, the network manager 20 senses the changes on the network, and performs management operations corresponding to each case.

In detail, in this embodiment, the communication means 110 is a means for performing communication according to the control protocol described above. The communication means 110 is installed inside or outside the network manager 20, for performing communication under the control of the control device 150.

The display means 120 is a device for displaying the state information or the control commands from the other network managers or the slave devices to the user. The input means 130 is a means for acquiring the command (for example, a selection command for a primary network manager) from the user. In addition, The input means 130 can acquire an input in association with the state information or the control commands displayed on the display means 120. The display means 120 and the input means 130 provide a user interface for the user.

The storing means 140 stores the homenet profile. The homenet profile consists of the set of device profiles containing the information on the individual network devices connected to the network. Each of the device profiles includes a device information file, a parameter file and a device operation file.

The device information file is data containing intrinsic device information of the individual network devices connected to the network. The device information file is stored in nonvolatile memories of the network devices, and transmitted to the network manager 20. Table 44 shows the structure of the device information file.

TABLE 44

| Name | Type | Description |
|---|---|---|
| ProductName | string | Name of device |
| MakerName | string | Name of device maker |
| ModelName | string | Name of device model |
| SWVersion | uchar | Software version with day/month/year |
| DeviceType | uchar | Kind of device: network manager, hybrid, slave |
| ProductCode | uchar | Product code |
| NoOfSvcCode | uint | Number of implemented service codes |
| | | (command codes) |
| SvcCode | ulong | Implemented service codes (command codes) |

The parameter file is data containing node parameters set in the individual network devices by the network configuration work, and stored in the nonvolatile memories of the network devices. Table 45 shows the structure of the parameter file.

TABLE 45

| Name | Type | Description |
|---|---|---|
| ProductCode | uchar | Product code |
| NP_LogicalAddress | uchar | Logical address |
| NP_ClusterCode | uchar | Cluster code |
| NP_OptionVal | ulong | Option value |
| NP_BufferSize | uchar | Size of communication buffer for APDU in |
| | | application layer |
| NP_AliveInt | uchar | Notification period time (second) |

The device operation file is data containing the operation states of the network devices, and stored in a nonvolatile memory of the network manager 20. Table 46 shows the structure of the device operation file.

TABLE 46

| Name | Type | Description |
|---|---|---|
| LastAliveEventTime | uchar | Last AliveEvent message reception time |
| | | (min.) |
| DeviceState | uchar | 0: offline state, 1: online state |
| Status | uchar | Detailed status information when device is |
| | | in online state |
| | | 0: standby, 1: operation, 2: temporary stop, |
| | | 3: product error |
| TimeOut | uint | Time (ms) taken for master device to wait |
| | | for response packet, after sending request |
| | | packet in unicast |
| Location | uint | Code value indicating installation space of |
| | | device |

Especially, LastAliveEventTime is a variable for storing the last message reception time to check the offline state, when AliveEvent message is not received for NP_AliveInt time.

The storing means 140 stores an initial logical address given in production (for example, a TV which is a network manager is set as 0x0000, an upper bit 0x00 is a product code representing the function of the network manager, and a lower bit 0x00 is the initial logical address which is the logical address of the network manager). In addition, the storing means 140 stores version information of the network management function installed in the network manager 20. The version information of the network management function includes version information of the control protocol and version information of the software.

After connected to the network, the master means 152 of the control device 150 performs the functions of the general master device in the same manner.

If any other network manager does not exist in the home network system 1, the slave means 154 of the control device 150 is not enabled. If the other network managers 21, 22 and 23 are active, as identical to the general slave device, the slave means 154 must provide information on the status change to the network managers 21, 22 and 23, or perform predetermined operations according to the control commands from the network managers 21, 22 and 23. Therefore, the information of the whole home network system 1 can be identically maintained in all the network managers 20 to 23 included in the home network system 1, so that the user can be provided with the precise information. When the network manager 20 is newly connected to the home network system 1, the slave means 154 additionally performs a function for configuration.

The operation of the network manager 20 by the control device 150 can be divided into network configuration, device management and network operation.

The network configuration includes setting of a domain code of the network, setting of a logical address and a parameter of the device, and device maintenance and management defining logical address initialization and information correction of the device. When the non-independent network communication medium is used, the domain code serves to distinguish a local network of one household from a local network of another household. Only the devices with the same domain code can communicate with each other on the network. The domain code is used in an appropriate type for the used physical medium. For example, a home code can be used as the domain code in the power line communication. In addition, PAN ID of IEEE 802.15.4 can be used.

The device management updates the homenet profile and manages the cluster list, by checking the device and monitoring the change. The network operation includes AliveEvent transmission, etc.

In the device management, the network managers 20 to 23 manage a device list. The network managers 20 to 23 can be constructed on the basis of the information of the homenet profile. The device list is divided into two as follows.

Registered Device List (hereinafter, referred to as ‘RDL’): The list of the network devices connected to the network at least once. The RDL excludes the network device deleted from the network according to a predetermined device deletion command (for example, SetDeviceDel service), and includes the network device which is not currently connected to the network but does not undergo a normal logical address deletion process. The network managers 20 to 23 must update the RDL by monitoring the changes or initializations of the addresses of the products. The master device or the secondary network manager can acquire the RDL from the primary network manager.

Active Device List (hereinafter, referred to as ‘ADL’): The list of the network devices currently connected to the network in the online state (active state) to perform communication. The network managers 20 to 23 can control the network devices of the list. The network managers 20 to 23 must update the ADL by monitoring the changes or initializations of the addresses of the network devices, and Plug-in and Plug-out states of the products. The master device or the secondary network manager can acquire the ADL from the primary network manager.

In accordance with the present invention, the basic interactions between the network managers 20 to 23 must be supported so that the network device can be applied to the environment in which the plurality of network managers 20 to 23 are operated as shown in FIG. 1. For this, the roles of the network managers 20 to 23 are divided as follows, and authority exchange is carried out therebetween.

Primary Network Manager (P-NM): The network manager with the network management function and the network management authority.

Secondary Network Manager (S-NM): The network manager which has the network management function but does not use the network management function, by transferring the network management authority to another primary network manager on the network.

Each of the network managers 20 to 23 stores their network manager types NMType. For example, the primary network manager stores ‘2’ and the secondary network manager stores ‘1’.

In the network configuration, at least one primary network manager is necessary. If the plurality of network managers exist on one network, it is recommended to convert the network managers into the primary/secondary network managers for efficient use of the network.

The network managers exchange the network management authority in the following cases.

(1) When the network manager newly joins the network,

when joining the network which does not have the network manager;

when joining the network which has the primary network manager; and

when joining the network which has the network manager but does not have the primary network manager; and

(2) When the primary network manager is disconnected from the network.

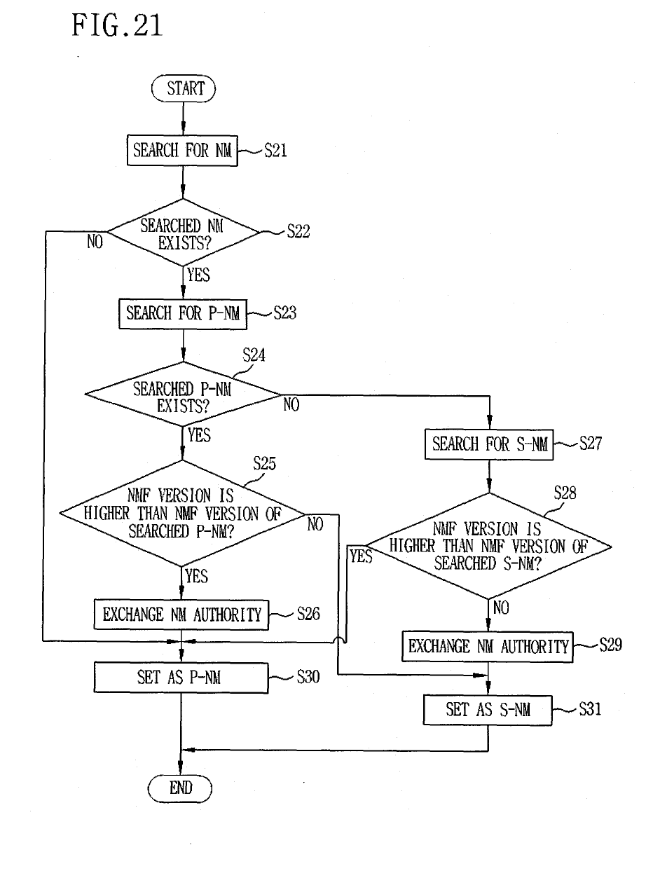

In the above cases, the network management authority is exchanged through a procedure of FIGS. 21 to 23.

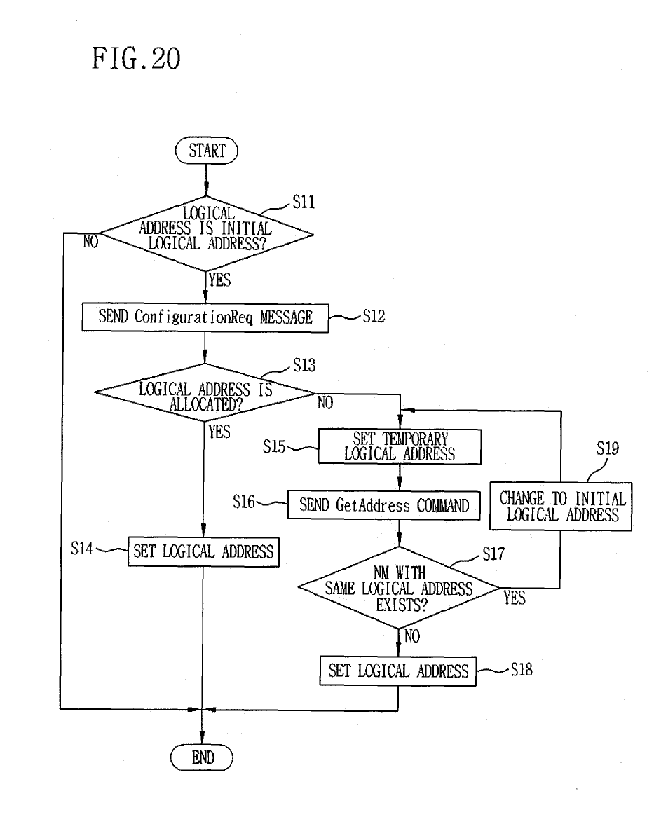

FIG. 20 is a flowchart showing sequential steps of a method for setting the logical address of the network manager in accordance with the present invention. When the network manager 20 is a new network device firstly connected to the network, as identical to the general network device, the network manager 20 preferentially performs a process for setting a unique logical address to be identified by the unique logical address. In this embodiment, it is presumed that the network manager 21 is the primary network manager, the network managers 22 and 23 are the secondary network managers, and the network manager 20 is the network manager newly getting the logical address.

In detail, in step S11, the network manager 20 is connected to the network and driven by power supply. It is judged whether the logical address stored in the storing means 140 is the initial logical address (for example, the address of 0x0000, upper 0x00 represents the network manager and lower 0x00 represents the logical address). If the stored logical address is the initial logical address, the network manager 20 is a network device newly connected to the network, and thus goes to step S12. If the stored logical address is not the initial logical address, since the unique logical address has already been set, the process for setting the logical address is ended.

In step S12, the control device 150 of the network manager 20 generates a configuration request message ConfigurationReg for requesting setting of the logical address, and sends the message to the network managers 21 to 23 through the network. As presumed above, if the primary network manager exists, the network manager 21 receiving the configuration request message ConfigurationReg selects a non-allocated logical address from the logical address range for the network manager (for example, 0x01˜0xFD). The network manager 21 allocates the selected logical address as the logical address of the network manager 20, and sends a response message containing the logical address to the network manager 20.

In step S13, the network manager 20 judges whether the logical address has been allocated, by checking reception of the response message containing the logical address through the network. If the network manager 20 receives the response message containing the allocated logical address, the network manager 20 goes to step S14. If not, the network manager 20 decides that the primary network manager connected to the network does not exist, and goes to step S15.

In step S14, the control device 150 of the network manager 20 stores the logical address of the received response message in the storing means 150 as the unique logical address of the network manager 20. That is, the prestored initial logical address is replaced by the received logical address.

In step S15, for example, the network managers 21 to 23 are all secondary network managers. The control device 150 selects one logical address from the logical address range, and sets the logical address as a temporary logical address. After the temporary logical address is set, it is included in senders of all messages.

In step S16, the control device 150 generates a logical address request message GetAddress, and sends the message to the network managers 21 to 23 through the network. The network managers 21 to 23 generate response messages containing at least their logical addresses, and send the response messages to the network manager 20 as the responses to the logical address request message GetAddress.

In step S17, the control device 150 receives the response messages, and judges whether the network manager having the same logical address as the temporary logical address exists, by comparing the logical addresses contained in the response messages with the temporary logical address, respectively. Here, the control device 150 compares the logical addresses having an upper address of 0x00 with the temporary logical address. If the network manager having the same logical address exists, the network manager 20 cannot use the preset temporary logical address, and thus goes to step S19. If the temporary logical address is the unique logical address, the network manager 20 goes to step S18.

In step S18, the control device 150 sets the preset temporary logical address as the unique logical address of the network manager 20.

In step S19, the control device 150 deletes the non-unique temporary logical address, and sets the initial logical address as the logical address. Thereafter, the network manager 20 goes up to step S15, and repeats the process for setting the logical address except the preset temporary logical address, to set the unique logical address.

In the above step S19, instead of deleting the temporary logical address and setting the initial logical address as the logical address, the network manager 20 can select the logical address which does not duplicate with the logical addresses of the network managers 21 to 23 from the logical address range, and set the selected logical address as its logical address.

FIG. 21 is a flowchart showing sequential steps of a method for setting a function of a network manager in accordance with a first embodiment of the present invention.

In detail, in step S21, the network manager 20 searches for the network manager through the connected network. To search for the network manager, the control device 150 generates the logical address request message GetAddress, and sends the message through the network. If any one network device is connected to the network, the network manager 20 can receive a response message to the logical address request message GetAddress. If the network manager 20 does not receive the response message, it means that any other network device is not connected to the network.

In step S22, the control device 150 judges whether the network manager connected to the network has been searched for, by checking the logical address having an upper address of 0x00 among the received logical addresses. If the searched network manager exists, the network manager 20 goes to step S23, and if not, the network manager 20 goes to step S30.

In step S23, the control device 150 searches for the primary network manager on the network. For this, the control device 150 generates a network manager search request message NMSearchReq, and sends the message to the network managers 21 to 23 through the network. Only the network manager whose network manager type NMType is ‘2’ can respond to the network manager search request message NMSearchReq. Table 47 shows the structure of the network manager search request message NMSearchReq, and Table 48 shows the structure of the response message.

TABLE 47

| | | Data | Data | |
|---|---|---|---|---|
| Data name | Description | type | size | Value |
| CommCode | Command code | const | 1 byte | 0x3E |
| | | uchar | | |
| NMType | Search target | uchar | 1 byte | 0: all NM, 1: S-NM, 2: |
| | kind | | | P-NM |
| FilterType | Search condition | uchar | 1 byte | 0: no condition, 1: NM |
| | kind | | | with higher NMF |
| | | | | version |
| Value | Search value | uchar | 1 byte | Condition value |

TABLE 48

| | | Data | Data | |
|---|---|---|---|---|
| Data name | Description | type | size | Value |
| CommCode | Command code | const | 1 byte | 0x3E |
| | | uchar | | |
| ACK | — | const | 1 byte | 0x06 |
| | | uchar | | |
| NMType | NM kind | uchar | 1 byte | 1: S-NM, 2: P-NM |
| FilterType | Search condition | uchar | 1 byte | 0: no condition, 1: NM |
| | kind | | | with higher NMF |
| | | | | version |
| Value | Search condition | uchar | 1 byte | Condition value |
| | value | | | |

In step S24, the control device 150 judges whether the searched primary network manager exists, by checking reception of the response message to the network manager search request message NMSearchReq. If the primary network manager has been searched for, the network manager 20 goes to step S25, and if not, the network manager 20 goes to step S27.

In step S25, the control device 150 judges whether the network management function version of the network manager 20 is higher than that of the primary network manager which has sent the response message. If the network management function version of the network manager 20 is higher, the network manager 20 goes to step S30, and if not, the network manager 20 goes to step S31. The network management function versions can be compared by sending the network manager search request message NMSearchReq in which the FilterType is set as ‘1’ and the Value is set as ‘the network management function version’. That is, the primary network manager 21 receiving the network manager search request message NMSearchReq compares its prestored network management function version with the value of the Value field of the received message. If its network management function version is higher (or equal or higher), the primary network manager 21 generates and sends the response message to the network manager 20. If its network management function version is equal or lower (or lower), the primary network manager 21 does not generate the response message.

In step S26, since the network management function version of the network manager 20 is higher, the control device 150 makes a request for the network management authority to the current primary network manager 21, and the current primary network manager 21 performs the network management authority exchange to give the network management authority to the network manager 20. In the network management authority exchange, Table 49 shows the structure of the request message for giving or requesting the authority, and Table 50 shows the structure of the response message to the request message.

TABLE 49

| | | Data | Data | |
|---|---|---|---|---|
| Data name | Description | type | size | Value |
| CommCode | Command code | const | 1 byte | 0x3F |
| | | uchar | | |
| Operation | Operation | uchar | 1 byte | 1: give management |
| | | | | authority, |
| | | | | 2: request |
| | | | | management authority |

TABLE 50

| | | Data | Data | |
|---|---|---|---|---|
| Data name | Description | type | size | Value |
| CommCode | Command code | const | 1 byte | 0x3F |
| | | uchar | | |
| ACK | — | const | 1 byte | 0x06 |
| | | uchar | | |
| OperationRes | Operation result | uchar | 1 byte | 1: get management |
| | | | | authority, |
| | | | | 2: give management |
| | | | | authority, |
| | | | | 0x0E: not P-NM |

In step S27, the control device 150 searches for the network manager which is the secondary network manager. The control device 150 uses the request message of Table 47, and sets NMType as ‘1’.

In step S28, the control device 150 judges whether the network management function version of the network manager 20 is higher than that of the searched secondary network manager, by using the request message of Table 47. Such judgment is made by using the response message of Table 48. If the network management function version of the network manager 20 is higher than that of the secondary network manager, the network manager 20 goes to step S30, and if not, the network manager 20 goes to step S31.

In step S30, the control device 150 sets the network management type NMType of the network manager 20 as P-NM, namely, ‘2’, and performs the function of the primary network manager.

In step S31, the control device 150 sets the network management type NMType of the network manager 20 as S-NM, namely, ‘1’, and performs the function of the secondary network manager.

By the above steps, one primary network manager and the plurality of secondary network managers exist on the network.

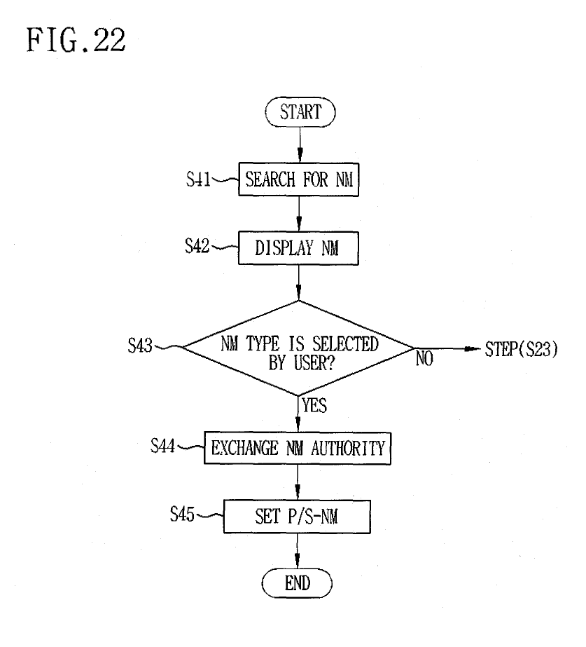

FIG. 22 is a flowchart showing sequential steps of a method for setting a function of a network manager in accordance with a second embodiment of the present invention.

In detail, in step S41, as identical to step S21 of FIG. 21, the control device 150 searches for the network manager connected to the network.

In step S42, the control device 150 displays the searched network manager and the network manager 20 itself on the display means 120.

In step S43, the control device 150 checks whether the user has made inputs for selecting the network management types NMType of the displayed network managers. That is, if the user intends to set the functions of the network managers by selecting the network management types NMType, the routine goes from step S43 to S44. If the user wants the network managers 20 to 23 to be automatically processed according to the method for setting the function of FIG. 21, the routine goes to step S23 of FIG. 21.

In step S44, according to the network management types NMType selected by the user, the network managers 20 to 23 exchange the network management authority of the primary network manager or the secondary network manager by using the messages of Tables 49 and 50.

In step S45, the control device 150 sets the network management authority of the network manager 20 as the primary network manager or the secondary network manager according to the selection input of the user.

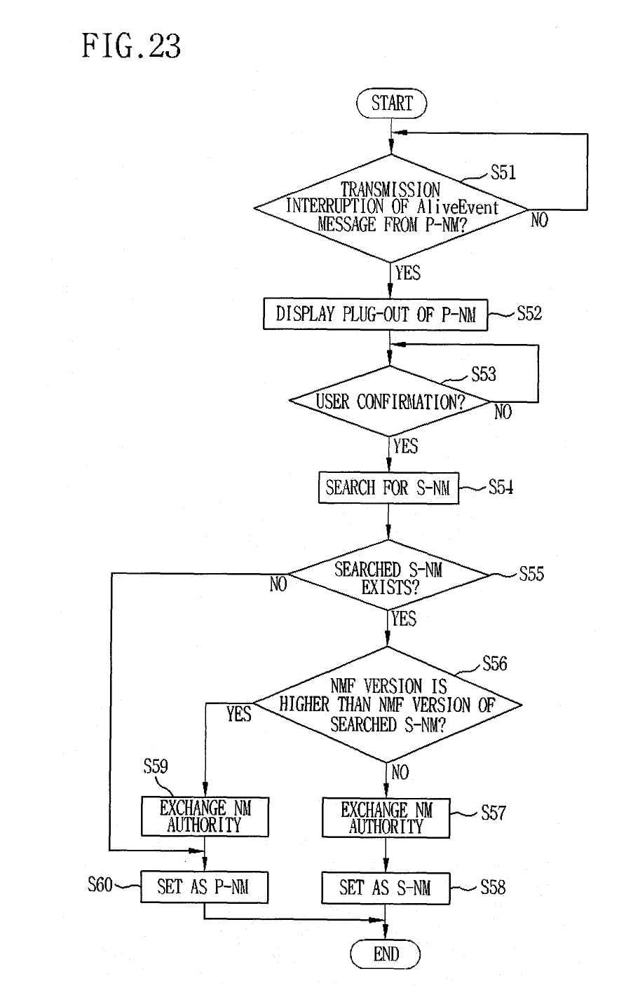

FIG. 23 is a flowchart showing sequential steps of a method for setting a function of a network manager in accordance with a third embodiment of the present invention. In this embodiment, when the primary network manager is disconnected from the network, namely, plugged out, one of the secondary network managers performs the network management function of the primary network manager.

In detail, in step S51, the network manager 20 judges whether the network manager 21 which is the primary network manager has not transmitted an alive event message AliveEvent over a predetermined time. The network managers 20 to 23 generate the alive event messages AliveEvent and send the messages to each other at intervals of a predetermined time. If the network manager 20 judges the transmission interruption, the network manager 20 goes to step S52.

In step S52, the control device 150 displays the plug-out state of the network manager 21 through the display means 120.

In step S53, the control device 150 maintains a standby state until the user inputs a confirmation input for the plug-out state of the network manager 21 through the input means 130. Such a confirmation input improves reliability in the judgment of the plug-out state of the network manager 21.

In step S54, the control device 150 searches for the secondary network manager by using the network manager search request message NMSearchReq of Table 47.

In step S55, the control device 150 checks whether the searched secondary network manager exists. If the searched secondary network manager does not exist, the network manager 20 is the only one secondary network manager, and goes to step S60. If another secondary network manager exists, the network manager 20 goes to step S56.

In step S56, the control device 150 performs the same operation as that of step S28 of FIG. 21.

In steps S57 and S58, the control device 150 performs the same operations as those of steps S29 and S31 of FIG. 21.

In steps S59 and S60, the control device 150 performs the same operations as those of steps S26 and S30 of FIG. 21.

As discussed earlier, the present invention easily embodies the network communication and the functions even in the low performance network device, by providing the functions for controlling and monitoring the other network devices in the home network system, and providing the plurality of unified primitives for transmitting the data.

The present invention can perform the network security and information processing according to the network media.

The present invention enables the electric device to perform the network communication through the adapter by communication with the adapter, even if the electric device does not have the high performance communication module.

The present invention can perform the communication security according to the transmission media through the home code sublayer of the data link layer.

When the network manager is newly connected to the network, the unique logical address is set in the network manager, to improve accuracy of the network communication.

The present invention sets the primary network manager and the secondary network manager according to the versions of the network managers or selection of the user. It is therefore possible to set and select the network management function.

The present invention can maintain the network management function, by transferring the network management function of the primary network manager plugged out of the network to another network manager.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A network device communicating with at least one electric device through a network, the network device adopting a protocol comprising:
an application layer for processing a message for controlling or monitoring the electric device;
a network layer for performing network connection to the electric device;
a data link layer for accessing a shared transmission medium; and
a physical layer for providing a physical interface with the electric device,
wherein the application layer further comprises an application sublayer for performing a network management function or managing device information.

2. The network device of claim 1, wherein, when the physical layer includes an extra protocol for providing an interface with a non-independent transmission medium, the adopted protocol further comprises a home code control sublayer for managing a home code for network security in connection to the non-independent transmission medium.

3. The network device of claim 2, wherein the home code control sublayer is formed in the data link layer.

4. The network device of claim 1, wherein the adopted protocol further comprises an application software for performing an intrinsic function of the network device, and providing an interface with the application layer.

5. The network device of claim 1, wherein the adopted protocol further comprises a parameter management plane for setting, acquiring or transferring parameters used in the application layer, the network layer, the data link layer or the physical layer.

6. A network adapter for performing data transmission between a first network and a second network, the network adapter adopting a protocol comprising:
a first layer unit for performing communication through the first network;
a second layer unit for performing communication through the second network; and
an upper layer for performing communication between the first layer unit and the second layer unit,
wherein, when the first network or the second network is a non-independent transmission medium, the first layer unit or the second layer unit comprises a home code control sublayer for managing a home code for network security.

7. The network adapter of claim 6, wherein the first layer unit and the second layer unit consist of a data link layer and a physical layer.

8. The network adapter of claim 7, wherein the home code control sublayer is formed in the data link layer.

9. The network adapter of claim 6, wherein the upper layer is a network layer.

10. A network device, comprising:
an electric device performing an intrinsic function, and including an upper layer for processing a message for controlling or monitoring; and
an adapter including a lower layer for performing communication through a network, an interface layer between the upper layer and the lower layer being formed in the electric device and the adapter, respectively.

11. The network device of claim 10, wherein asynchronous serial communication is performed between the interface layers.

12. A network device, comprising:
an electric device performing an intrinsic function, and including an upper layer for processing a message for controlling or monitoring and performing network communication with another electric device; and
an adapter including a lower layer for accessing a network which is a transmission medium, an interface layer between the upper layer and the lower layer being formed in the electric device and the adapter, respectively.

13. The network device of claim 12, wherein asynchronous serial communication is performed between the interface layers.

14. A method for setting an address of a network device communicating with another network device through a network, the method comprising the steps of:
sending, at one network device, a configuration request message to another network device;
when one network device receives a response message to the configuration request message, setting a logical address contained in the response message as a logical address of one network device; and
when one network device does not receive the response message to the configuration request message, setting a temporary logical address.

15. The method of claim 14, further comprising the steps of:
sending a logical address request message to another network device; and
receiving a response message to the logical address request message, after the step for setting the temporary logical address.

16. The method of claim 15, comprising the steps of:
checking whether the temporary logical address is a unique logical address, by comparing a logical address contained in the response message to the logical address request message with the temporary logical address;
when the temporary logical address is the unique logical address according to the checking result, setting the temporary logical address as the logical address of one network device; and
when the temporary logical address is not the unique logical address, setting an initial logical address as the logical address of one network device.

17. The method of claim 16, which performs the step for setting the temporary logical address, after performing the step for setting the initial logical address.

18. A method for setting a function of a network manager communicating with a network device through a network, the method comprising the steps of:
searching, at one network manager, for another network manager; and
when another network manager is searched for in the search step, setting one network manager as a primary network manager or a secondary network manager according to a network management function version of the searched network manager.

19. The method of claim 18, comprising a step for setting one network manager as the primary network manager, when another network manager is not searched for.

20. The method of claim 18, wherein the setting step comprises a step for exchanging network management authority with another network manager.

21. The method of claim 18, wherein the setting step comprises the steps of:
searching, at one network manager, for a primary network manager; and
when the searched primary network manager exists, comparing a network management function version of the primary network manager with a network management function version of one network manager,
wherein one network manager is set as the primary network manager or the secondary network manager according to the comparison result of the network management function versions.

22. The method of claim 21, wherein the setting step comprises the steps of:
when the primary network manager is not searched for, searching, at one network manager, for a secondary network manager; and
comparing a network management function version of the secondary network manager with a network management function version of one network manager,
wherein one network manager is set as the primary network manager or the secondary network manager according to the comparison result of the network management function versions.

23. A method for setting a function of a network manager communicating with a network device through a network, the method comprising the steps of:
searching for a network manager;
displaying the network manager connected to the network according to the search result;
acquiring selection of the user for a primary network manager or a secondary network manager with regard to the displayed network manager; and
setting the network manager as the primary network manager or the secondary network manager according to the acquired selection of the user.

24. The method of claim 23, wherein the setting step comprises a step for exchanging network management authority between the network managers.

25. A method for setting a function of a network manager communicating with a network device through a network, the method comprising the steps of:
checking a plug-out state of a primary network manager;
when the primary network manager has the plug-out state according to the checking result, searching, at one network manager, for a secondary network manager; and
when the secondary network manager is searched for in the search step, setting one network manager as a primary network manager or a secondary network manager according to a network management function version of the searched secondary network manager.

26. The method of claim 25, comprising a step for displaying the checking result to the user.

27. The method of claim 25, which performs the search step after acquiring a confirmation input for the plug-out state of the primary network manager from the user.

28. The method of claim 25, comprising a step for setting one network manager as the primary network manager, when the secondary network manager is not searched for in the search step.
